(19) United States
(12) Patent Application Publication
(10) Pub. No.: US 2025/0193282 A1
(43) Pub. Date: Jun. 12, 2025

(54) Node Synchronization and Event Localization in Industrial Internet of Things Systems

(71) Applicant: Volta Insite, Inc., Cornelius, NC (US)

(72) Inventors: Takis Constantine Zourntos, Toronto (CA); Denis Kouroussis, Markham (CA); Daniel Montbriand, Santa Cruz, CA (US); Karl Lindstrom, Sunnyvale, CA (US)

(21) Appl. No.: 18/950,356

(22) Filed: Nov. 18, 2024

Related U.S. Application Data
(60) Provisional application No. 63/607,688, filed on Dec. 8, 2023.

(51) Int. Cl. H04L 67/12; G16Y 40/20; H04L 7/02

(52) U.S. Cl. CPC H04L 67/12; G16Y 40/20; H04L 7/02

(57) ABSTRACT

An industrial internet of things (IIoT) system includes a cloud-based computing platform that is communicatively coupled to one or more IoT-enabled facilities and configured to receive, over private and secure communications links, data captures from IoT nodes in the one or more IoT-enabled industrial facilities. The IoT nodes are coupled to machines and other electrical devices in electrical distribution networks within the one or more IoT-enabled industrial facilities, and the cloud-based computing platform is operable to identify and temporally correlate events in the data captures that are of diagnostic or predictive value. Using localization information gleaned from temporally correlating a given event, the cloud-based computing platform is further operable to pinpoint a location within the corresponding IoT-enabled industrial facility where the given event originated and, when applicable, the root cause of the event and any machine(s) and/or equipment that caused or is/was affected by or associated with the given event.

### CROSS-REFERENCE TO RELATED APPLICATIONS

This application claims the benefit of U.S. Provisional Patent Application No. 63/607,688, filed Dec. 8, 2023.

### BACKGROUND OF THE INVENTION

Internet of Things (or “IoT”) technology is used in consumer applications, for example, home automation systems that monitor and control lighting, heating, air conditioning, cameras, security systems, etc. in residences. It is also increasingly being used in industrial environments, such as factories, assembly plants, mills, and electrical power generation facilities, where it is referred to as “industrial IoT” (or “IIoT”). These industrial environments include fans, blowers, drills, saws, pumps, conveyor belts, and other industrial machines that are driven by large electrical motors, as well as other associated electrical infrastructure, for example, transformers, switchgear, electrical distribution wiring, etc.

When operating in industrial environments, electrical motors and their coupled mechanical systems are often presented with extreme loads which can lead to unexpected breakdowns. State-of-the-art IIOT systems can aid in monitoring performance and detecting occurrences of breakdowns. However, they have no effective and reliable means for quickly determining and identifying the root causes of a breakdowns. Determining and identifying the root cause of any given breakdown is difficult, given that modern industrial facilities often contain hundreds and even thousands of interacting mechanical and electromechanical devices. Because of these limitations of state-of-the-art IIOT systems, a technician must therefore be dispatched to the facility once a breakdown occurs, in hopes that the technician will be able to quickly identify the root cause of the breakdown.

Any inability to quickly and reliably determine and identify the root cause of a breakdown results in significant facility downtime. Downtime costs are expensive; they can accrue rapidly and even surpass the replacement cost of any new equipment that must be installed to overcome the breakdown. The exigency to overcome a breakdown is therefore often intense, and if the technician is unable to, or is not provided with sufficient time to, determine and identify the root cause of the problem, a management decision may be made to simply replace any apparently-affected equipment with new equipment, in a blind attempt to rectify the problem. However, without having actually determined and identified the root cause of the problem, the problem may very will likely reoccur, even with the new equipment installed, leading to further downtime and replacement costs.

The present invention, described in detail below, addresses and provides solutions to these problems.

### BRIEF SUMMARY OF THE INVENTION

An industrial internet of things (IIoT) system includes a cloud-based computing platform that is communicatively coupled to one or more IoT-enabled facilities and configured to receive, over private and secure communications links, data captures from IoT nodes in the one or more IoT-enabled industrial facilities. The IoT nodes are coupled to machines and other electrical devices in electrical distribution networks within the one or more IoT-enabled industrial facilities, and the cloud-based computing platform is operable to identify and temporally correlate events in the data captures that are of diagnostic or predictive value. Using localization information gleaned from temporally correlating a given event, the cloud-based computing platform is further operable to pinpoint a location within the corresponding IoT-enabled industrial facility where the given event originated and, when applicable, the root cause of the event and any machine(s) and/or equipment that caused or is/was affected by or associated with the given event.

Further features and advantages of the invention, including a detailed description of the above-summarized and other exemplary embodiments of the invention, will now be described in detail with respect to the accompanying drawings, in which like reference numbers are used to indicate identical or functionally similar elements.

### BRIEF DESCRIPTION OF THE DRAWINGS

FIG. 1 is a drawing of an industrial internet of things (IIoT) system, according to one embodiment of the present invention;

FIG. 2 is a block diagram of a virtual server that may be used in embodiments of the present invention where the cloud-based computing platform of the IIoT system depicted in FIG. 1 is implemented in a virtual private cloud (VPC);

FIG. 3 is a block diagram of a dedicated server that may be used in embodiments of the present invention where the cloud-based computing platform of the IIoT system depicted in FIG. 1 is implemented in a private cloud rather than in a VPC;

FIG. 4 is a drawing of an IIOT system, according to another embodiment of the present invention;

FIG. 5 is a drawing illustrating the connectivity of one of the IoT nodes deployed in the IoT-enabled industrial facility of the IIOT system depicted in FIG. 1 to an associated sensor module and further highlighting the IoT node's operability of collecting current- and voltage-related “data captures” from the associated sensor module, in accordance with one embodiment of the present invention;

FIG. 6A is a drawing illustrating how the work cycle detector in the cloud-based computing platform of the IIoT system depicted in FIG. 1 is implemented, in accordance with one embodiment of the present invention;

FIG. 6B is a graph illustrating the detection of a work cycle among input raw data and noise by the work cycle detector depicted in FIG. 6A;

FIG. 7 is a drawing of a control module and associated controlled three-phase induction motor, highlighting the control module's service as a variable-frequency drive (VFD) and its operability of responding to commands from an IoT node in the IIoT system depicted in FIG. 1 or, alternatively, from a control agent located within the cloud-based computing platform of the IIOT system, in accordance with one embodiment of the present invention;

FIG. 8 is a drawing depicting how an IoT node an associated sensor module in the IIOT system depicted in FIG. 1 are constructed, in accordance with one embodiment of the present invention;

FIG. 9 is a drawing including a graph of a normal three-phase voltage waveform, a graph of a three-phase voltage waveform that has become distorted due to a contactor bounce event, and a timing graph highlighting when the contactor bounce event begins and ends;

FIG. 10 is a drawing algorithmically illustrating the salient features of an event identifier, in accordance with one aspect of the present invention;

FIG. 11 is a drawing illustrating the primary constituents involved in the pairwise synchronization of IoT nodes, in accordance with one embodiment of the present invention;

FIG. 12 is a flowchart depicting a high-precision synchronization process used to synchronize a pair of IoT nodes to sub-millisecond precision, in accordance with one embodiment of the present invention;

FIG. 13 is a timing diagram illustrating the multi-point virtual oscilloscope capability of the present invention, specifically (in this example), the ability of all three separate synchronized IoT nodes to capture a glitch event in a common window of time;

FIG. 14 is a drawing highlighting that two IoT nodes, Node A and Node B, are “coincident” in circumstances where their associated machines and switchgear are connected to a common transformer;

FIG. 15 is a drawing highlighting that two IoT nodes, Node D and Node B, are “dissociated” in circumstances where their associated machines and switchgear are connected to different transformers located upstream/downstream from one another;

FIG. 16 is drawing of simplified multi-node network used to illustrate the localization of an event, in accordance with embodiment of the present invention;

FIG. 17 is a drawing of an event-statistics table stored in a Node-Node Connection, Event-Statistics and Record (N²CESaR) database of the cloud-based computing platform of the IIT system depicted in FIG. 1, in accordance with one aspect of the present invention;

FIG. 18 is a diagram that combines attributes of a single-line drawing (SLD) of a particular IoT-enabled industrial facility (corresponding to the generalized IoT-enabled industrial facility depicted in FIG. 1) with IoT node connectivity (per transformer), and which can be used in conjunction with FIG. 19 to conceptualize the spatial correlation of events, i.e., “pinpointing” process, aspect of the present invention;

FIG. 19 is a flowchart depicting a pinpointing process, which when applied affords the ability to determine the physical location of an event occurrence in the IoT-enabled industrial facility of the IIOT system depicted in FIG. 1;

FIG. 20 is a diagram of a portion of the particular IoT-enabled industrial facility diagram depicted in FIG. 18, highlighting a tracing algorithm that can be performed to pinpoint events and including a data-structure representation of the physical topology of the portion of the particular IoT-enabled-specific diagram with SLD-level nodes and “supernodes,” in accordance with one aspect of the present invention;

FIG. 21 is a flowchart depicting an event-statistics updating method that is performed to update the event-statistics table stored in the N²CESaR database (see FIG. 17, for example), in accordance with one aspect of the present invention;

FIG. 22A is a flowchart summarizing various processes performed by the cloud-based computing platform and IoT-enabled industrial facility of the IIoT system depicted in FIG. 1;

FIG. 22B is a continuation of the flowchart depicted in FIG. 22A for situations where the detected/identified event is diagnostic in nature; and

FIG. 22C is a continuation of the flowchart depicted in FIG. 22A for situations where the detected/identified event is predictive in nature.

### DETAILED DESCRIPTION

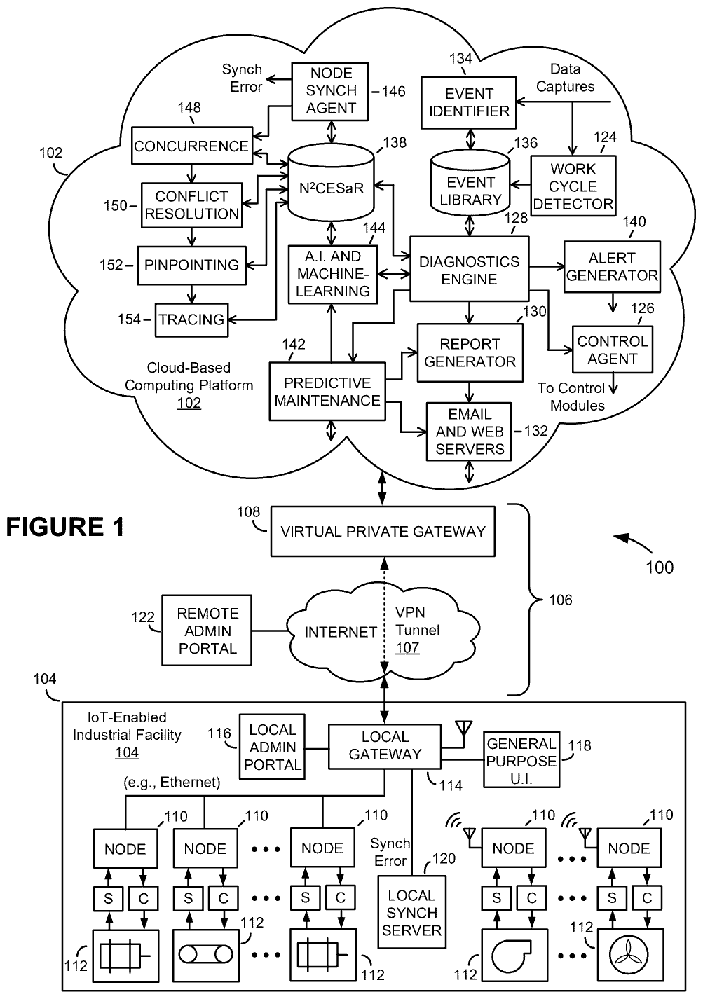

Referring to FIG. 1, there is shown an industrial internet of things (IIoT) system 100 according to one embodiment of the present invention. The IIOT system 100 comprises a cloud-based computing platform 102 and an IoT-enabled industrial facility 104 which is communicatively coupled to the cloud-based computing platform 102 via a secure and private communications link 106. The cloud-based computing platform 102 comprises a virtual private cloud (VPC) maintained by a cloud service provider, such as Amazon Web Services (AWS), Microsoft, or Google, or may alternatively comprise a non-shared, corporate-controlled private cloud. The IoT-enabled industrial facility 104 comprises a factory, assembly plant, mill, electrical power generation facility, or other industrial facility, equipped with IoT nodes 110 (also referred to simply as “nodes” in the description that follows) that monitor and collect data from associated electrical machines and electrical equipment within the facility 104, and, as will be described in detail below, upload the data that they collect to the cloud-based computing platform 102, via the private and secure link 106. In one embodiment of the invention the private and secure link 106 comprises a site-to-site virtual private network (VPN) tunnel 107 and virtual private gateway 108, as depicted in FIG. 1, but may alternatively comprise a direct private connection provided by the cloud service provider (e.g., “AWS Direct Connect” if AWS is the cloud service provider) that shields the data that the IoT nodes 110 upload to the cloud-based computing platform 102 from exposure to the public internet, as well as other sensitive facility-related information and cloud-to-facility and facility-to-cloud communications.

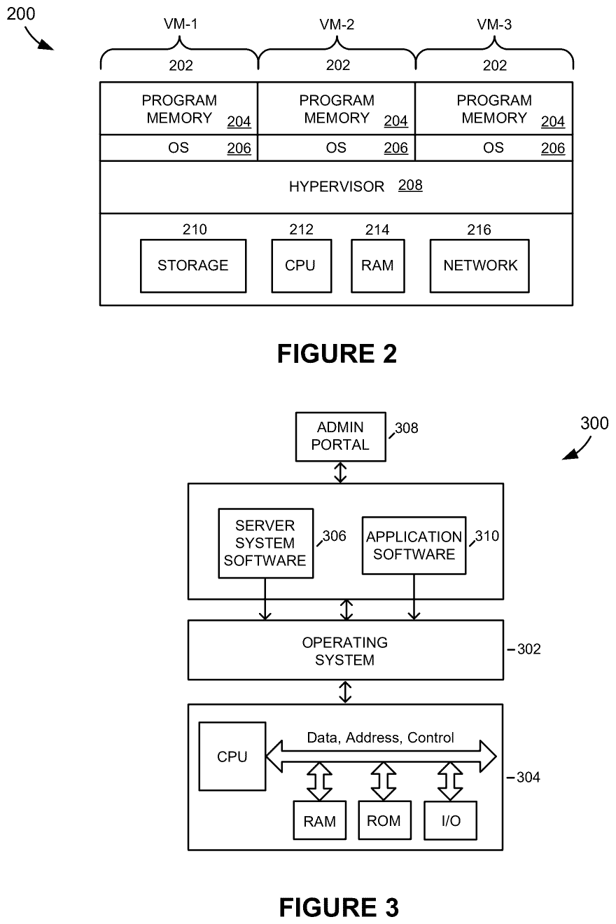

In embodiments of the present invention where the cloud-based computing platform 102 is implemented in a VPC, the cloud service provider provides the storage and computing resources needed to store the various databases and run the various cloud-based software programs depicted in the cloud symbol in FIG. 1. More specifically, as illustrated in FIG. 2, one or more virtual servers 200 are provided by the cloud service provider, with each virtual server 200 comprising one or more virtual machines (VMs) 202 having a predetermined allocation of program memory 204. The VMs 202 are created and managed by a hypervisor 208, which also manages the storage 210, central processing unit (CPU) 212, random access memory (RAM) 214, and networking 216 resources shared among the VMs 202. Finally, each VM 202 is preferably, though not necessarily, independently configurable to operate according to the cloud service subscriber's preferred operating system (OS) 206.

In embodiments of the IIoT system 100 that utilize a private cloud approach to implement the cloud-based computing platform 102, in other words, instead of a VPC, one or more dedicated servers, rather than one or more VMs, are used to run the various cloud-based programs depicted in FIG. 1. In other words, as illustrated in FIG. 3, one or more dedicated servers 300, each having its own, non-shared OS 302 and dedicated hardware 304 (CPU, RAM, program memory, etc.) is/are used. The one or more dedicated servers 300 also have their own, non-shared system software 306, a secure/private admin portal 308, and application software 310 corresponding to the various cloud-based computer programs depicted in FIG. 1.

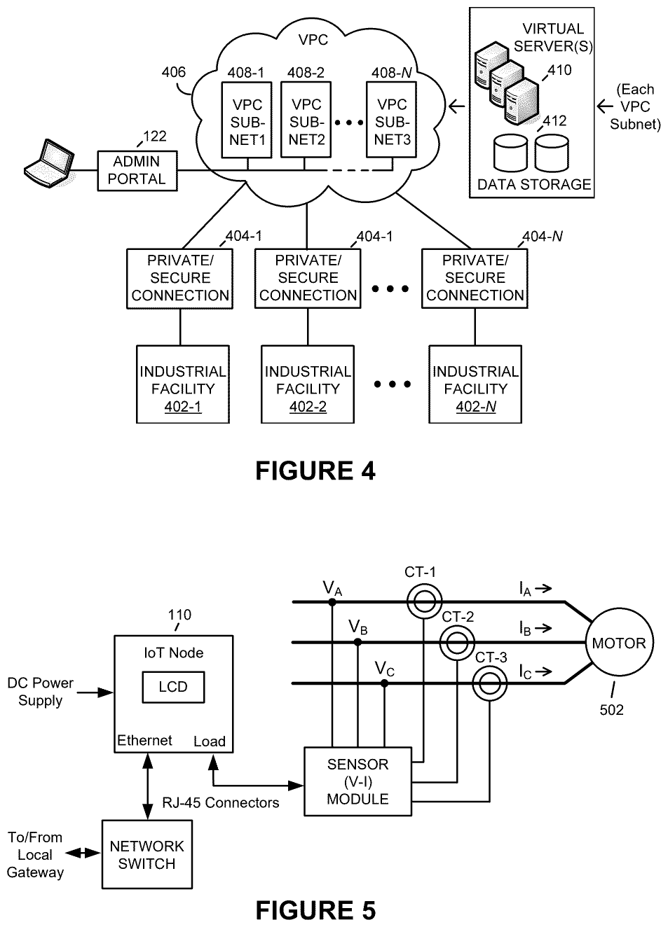

The IIoT system 100 depicted in FIG. 1 is shown to serve just a single IoT-enabled industrial facility 104. However, in a preferred embodiment of the present invention, illustrated in FIG. 4, the IIOT system 100 is designed to serve multiple industrial facilities 402-1, 402-2, . . . , 402-N spanning a wide geographical area, for example, industrial facilities nation-wide or world-wide. Each industrial facility 402-1, 402-2, . . . , 402-N has its own private and secure connection 404-1, 404-2, . . . , 404-N to the cloud-based computing platform 406, which may comprise, for example, a single VPC partitioned into multiple subnets 408-1, 408-2, . . . , 408-N (as depicted in FIG. 4), with each subnet having virtual server(s) 410, data storage 412, and networking resources provided to it by the cloud service provider. Alternatively, multiple VPCs partitioned into one or more subnets may be used, or, if a private cloud implementation is used instead of one or more VPCs, one or more private clouds are used to provide service to the multiple industrial facilities 402-1, 402-2, . . . , 402-N.

From the foregoing description it should be clear that the cloud-based computing platform 102 depicted in FIG. 1 can be implemented in either a VPC comprising one or more virtual servers 200 or in a corporate-controlled private cloud comprising one or more dedicated servers 300. It should also be mentioned that the computing resources of these servers and/or associated storage resources (e.g., the storage used to store the event library and N²CESaR databases 136 and 138) may be distributed, either in a single cloud or among a plurality of different overlapping or non-overlapping cloud environments, and that one or more of the various programs denoted in FIG. 1 may be adapted, depending on the application and the particular cloud implementation adopted, so it/they is/are executable on more than one computer/server, either within a single isolated cloud or within multiple cloud environments. In the remaining description that follows, these servers/computers, whether they be virtual machines in one or more VPCs or dedicated servers/computers in one or more corporate-controlled private clouds, is/are referred to as one or more “cloud computers.”

The IoT nodes 110 in the IoT-enabled industrial facility 104 are configured to collect sensor data from sensor modules (labeled with an “S” in FIG. 1) which are connected or coupled to machines and electrical devices 112 (e.g., motors, blowers, fans, transformers, relays, contactors, switches, etc.) deployed throughout the facility 104. As illustrated in FIG. 5, this sensor data includes three-phase voltage data derived from three-phase voltage measurements VA, VB and Vc taken at the three-phase power inputs of the machines and electrical devices (an electrical motor 502, for example, as in FIG. 5) and three-phase current data derived from three-phase current measurements IA, IB and Ic taken by current transformers CT-1, CT-2 and CT-3 at the three-phase power inputs. In one embodiment of the invention, each IoT node 110 is configured to collect the three-phase voltage and current data from its associated sensor module on six data channels at periodic intervals (e.g., every 15 minutes) and for a predetermined duration (e.g., 40 seconds). These “data captures” are temporarily stored within the local memories of the IoT nodes 110 and subsequently transmitted (asynchronously or periodically) to the cloud-based computing platform 102. More specifically, each IoT node 110 includes a wired and/or wireless transceiver which it uses to transmit its data captures over a wired or wireless local link (e.g., wired Ethernet or Wi-Fi local area network (LAN)) to a local gateway 114, which then uploads the data captures to the cloud-based computing platform 102 via the private and secure link 106. In one embodiment of the invention, the data captures collected from each IoT node 110 are uploaded independent of the other IoT nodes 110 and multiple parallel data pipes are used to facilitate the uploading. In another embodiment, the IoT nodes 110 are configured to upload their data captures sequentially, according to a predetermined time schedule, for example.

The amount of data storage needed to store the many data captures uploaded to the cloud-based computing platform 102 can be large, particularly when there are a large number of IoT nodes in the IoT-enabled industrial facility 104. To help reduce the number of uploads, in one embodiment of the invention the cloud-based computing platform 102 includes a work cycle detector 124. The work cycle detector 124 analyzes the work cycles of machines deployed throughout the industrial facility 104, based on previous data captures, and determines the work cycles of the various machines. Once the work cycles are determined, the associated IoT nodes 110 are then configured to upload the data captures of their associated machines only for times during which the machines are actually doing work, in other words, only for their respective work cycles. In this way, the number of data captures uploaded to the cloud-based computing platform 102 and the amount of cloud storage needed to store the data captures is minimized. As will be discussed in more detail below, the work cycle detector 124 may also be configured and exploited to: 1) improve the probability of identifying and diagnosing events associated with machines that operate according to short work cycles; and 2) facilitate the synchronization of the IoT nodes 110.

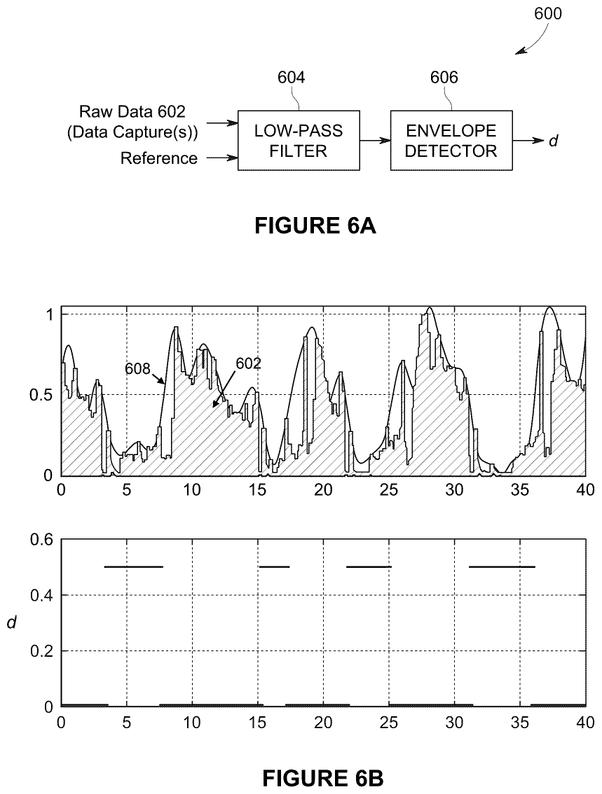

The work cycle detector 124 comprises a cloud-based computer program that runs on one or more cloud computers of the cloud-based computing platform 102. Alternatively, it is a computer program executed by processors within the IoT nodes 104 themselves. In general, and as illustrated in FIG. 6A, the work cycle detector 600 comprises a low-pass filter function 604 and an envelope function 606. The low-pass filter function 604 operates to remove noise from the input raw data 602 and the envelope function 604, operating according to a peak, RMS, or analytic (e.g., spline-fitting) algorithm, fits a signal envelope 608 to the raw data 602, as illustrated in the graph presented in FIG. 6B. The work cycle detector 600 indicates a work cycle is found whenever, d, the output of the detector 600, is zero, as illustrated in the lower-half of FIG. 6B.

In addition to collecting data from their associated sensor modules and transmitting data captures to the cloud-based computing platform 102, the IoT nodes 110 may be further configured to control various operational aspects of their associated machines and/or electrical devices 112. For example, in one embodiment of the invention, control modules (labeled with a “C” in FIG. 1) are configured to respond to commands (originating from the IoT nodes 110 themselves or from a control agent 126 located within the cloud-based computing platform 102) that directs the control modules to adjust or alter the operation of associated machines and electrical devices within the industrial facility 104, for example, by directing a control module associated with a particular IoT node 110 and associated machine to activate an actuator that disconnects electrical power from the particular machine when conditions warrant. Preferably, like the sensor modules, the control modules (or at least their corresponding actuators) are situated in close proximity to the machines they are configured to control, for example, housed within a fuse-disconnect or motor control cabinet.

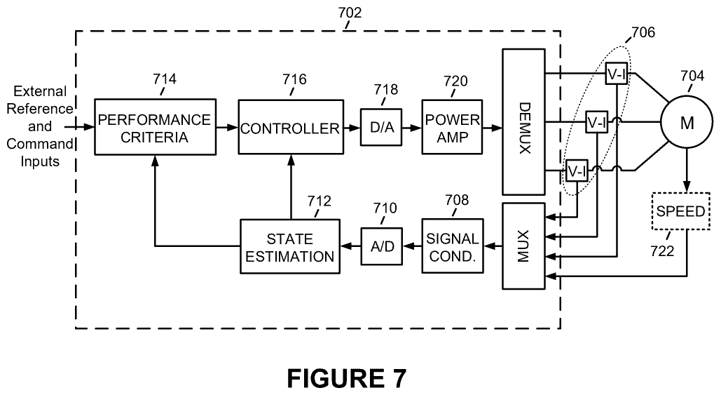

In other embodiments of the invention one or more of the control modules is/are further or alternatively operable to control the speed (or other performance parameter, criterion, or metric) of their associated machines. FIG. 7 is a drawing illustrating how a control module 702 may be adapted to support this aspect of the present invention, specifically, in a situation where the controlled machine comprises a three-phase induction motor 704. In such an application, the control module 702 comprises a feedback-based speed controller that serves as a variable-frequency drive (VFD). By virtue of the negative feedback, the control module 702 is capable of rapid and large speed changes, even from rest, with minimal overshoot-results which are difficult or in some cases even impossible to realize in conventional open-loop VFD control systems. Moreover, speed control and speed regulation can be achieved even in the absence of speed sensors. Specifically, using only digital motor voltage and motor current data obtained from voltage and current sensors 706 placed on or in the vicinity of the motor 704 (first filtered by a signal conditioning block 708 and digitized by analog-to-digital converter (A/D) 710), a state estimation block 712 in the control module's 702's negative feedback path produces a real-time estimate of the motor's 704's speed or other operational state (i.e., performance criterion). A feedback signal representing the real-time estimate is then directed to a performance criteria block 714, which compares the real-time estimate to an external reference signal representing the desired operational state of the motor 704 (e.g., desired speed, torque, rms current level, etc.). Based on the comparison a controller 716 then generates a control signal, which is then converted to an analog waveform by a digital-to-analog converter (D/A) 718, amplified, as necessary, by a power amplifier 720, and finally demultiplexed into three-phase VFD voltage and current waveforms that force the motor 704 to adjust to the desired operational state specified by the external reference signal (e.g., to increase or decrease the motor's speed or torque). (Note: If a speed controller is present, as indicated by the optional speed controller 722 in FIG. 7 and/or real-time measurements of the stator's magnetic field in the motor 704 are available, those measurement can be sent directly to the performance criteria and controller blocks 714 and 716, in other words, instead of relying solely on the state estimation block 712 to produce estimates of those variables.)

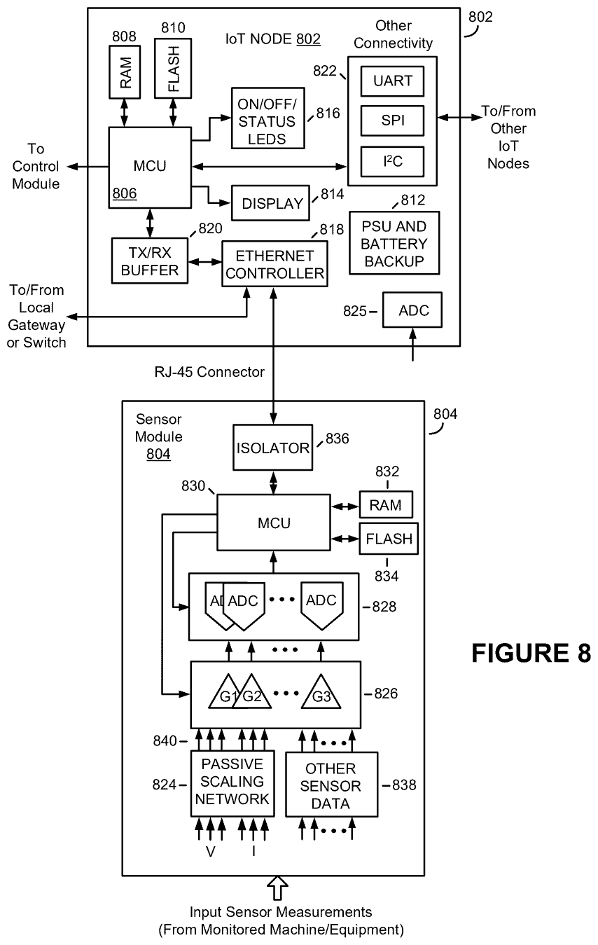

FIG. 8 illustrates in further detail how an IoT node 110 and associated sensor module are constructed according to one embodiment of the present invention. Each IoT node 802 includes its own processor 806 (e.g., a microcontroller unit (MCU) 806) configured to operate according to a multitasking OS such as Linux; RAM 808; nonvolatile program memory (e.g., Flash memory and/or electrically-erasable programmable read only memory (EEPROM)) 810; a power supply unit (PSU) and battery backup unit 812; a display 814 (e.g., a liquid crystal display (LCD)) that displays information about the IoT node 802 (e.g., its serial number, IP address within the local network, and real-time three-phase voltage current readings of the associated machine or electrical device being monitored by the IoT node 802); and optional light-emitting diodes (LEDs) 816, which indicate the operational state of the IoT Node 802, for example, whether the IoT node 802 is on, off, or in some other operational state. The exemplary IoT node 802 also includes an Ethernet controller 818 and transmit/receive (TX/RX) buffer 820 (both of which may be embedded within the MCU 806), which together facilitate the Ethernet wired-networking protocol. Each IoT node 802 may also or alternatively include a wireless transceiver that allows the IoT node 802 to communicate its data captures to the local gateway 114 wirelessly. Other connectivity types 822 may also be included in the IoT node 802, such as an Inter-Integrated Circuit (I²C) bus, serial peripheral interface (SPI), and/or a universal asynchronous receiver-transmitter (UART), to thereby allow node-to-node communications. Finally, the IoT node 802 may optionally include an ADC 825, to support an optional design in which analog-to-digital conversion is performed in the IoT node 802, rather than in the sensor module 804.

Each sensor module 804 is coupled or connected to an associated machine 112 or electrical device (e.g., a three-phase induction motor, transformer, relay, contactor, switch, etc.) within the IoT-enabled industrial facility 104, and, as illustrated in FIG. 8, each sensor module 804 comprises: a passive scaling network 824; a variable gain amplifier stage 826; an analog-to-digital converter (ADC) 828; an MCU 830 with associated RAM 832 and nonvolatile program memory 834, which stores the firmware and program instructions for controlling the sensor module's 804's operation and its interaction with the IoT node 802; and an isolator 836 that provides electrical isolation between the IoT node 802 and sensor module 804. Depending on the application, the sensor module 804 may also include one or more additional input sensor channels for receiving other sensor data 838 from other sensors that are configured to detect or measure other machine- and equipment-related attributes, such as vibration, temperature, light, sound, pressure, displacement, tension, strain, rectilinear speed, rotational speed, acceleration, changes in weight, power factor, etc.

The scaled three-phase voltage and current measurements 840 produced at the output of the passive scaling network 824 and other sensor data 838 are amplified by the variable gain amplifier stage 826, converted to high-resolution sensor data by the ADC 828, and finally communicated to the IoT node 802 via an Ethernet cable (RJ-45 connection). Alternatively, the IoT node 802 and sensor module 804 are equipped with wireless transceivers, in which case the high-resolution sensor data is communicated wirelessly from the sensor module 804 over a wireless link to the IoT node 802.

In one embodiment of the invention all of the IoT nodes 802 deployed in the IoT-enabled industrial facility 104 are housed within a low-voltage cabinet, for example, a low-voltage information technology (IT) cabinet, in which case the IoT nodes 110 may be collectively considered a part of the facility's 104's IT infrastructure. Housing the IoT nodes 110 in a low-voltage cabinet is desirable from the standpoint that it prevents the low-voltage electronics in the IoT nodes 110 from being accidentally exposed to high voltages and high currents that their respective sensor modules 804 are often exposed to as they monitor their respective machines 112 and associated electrical devices. Insofar as the present invention is concerned, however, the IoT nodes 802 and their corresponding sensor modules 804 need not be physically separated and may be collocated near the machines and electrical equipment they are measuring. For example, in one embodiment of the invention the various functions performed by the IoT node 802 and sensor module 804 are integrated into one or more integrated circuit chips and mounted on a common printed circuit board.

In the description of FIG. 8 above it was assumed that each IoT node 802 collects sensor data from just a single associated sensor module 804. However, it should be mentioned that a single IoT node 110 (802) can be configured so that it receives sensor data from multiple sensor modules 804.

It should also be mentioned that, in accordance with one embodiment of the invention, the IoT nodes 802, sensor modules 804, and/or command modules are customizable, in other words, can be pre-calibrated and customized prior to or during installation within a given industrial facility 104, taking into account the facility's 104's electrical equipment and specifications, including, for example, full-load current and speed, horsepower, (VFD, soft-starter, off-the-line start, reversible), controls, etc. The facility's 104's mechanical setup, such as gearboxes and pulleys, etc. may also be factored into the customization and pre-calibration.

As further illustrated in FIG. 1, the IIOT system 100 includes local and remote admin portals 116 and 122. The local and remote admin portals 116 and 122 allow a system administrator to view and monitor system operations, facility-related data, including the data captures that the IoT nodes 110 upload to the cloud-based computing platform 102. By providing access to this data, the system administrator is then able to identify problems or potential problems relating to the operation of the various machines and electrical equipment deployed within the facility 104, and notify the facility supervisor of any identified problems, potential problems, or other concerns.

In one embodiment of the invention, the local and/or remote admin portals 116 and 122 are equipped with software applications that provide the system administrator the additional ability to adjust and fine-tune sense and control parameters affecting the operation of the IoT nodes 110 (802), sensor modules 804, and control modules, thereby improving diagnostic accuracy and control and reducing false positive event detection rates.

The IoT-enabled industrial facility 104 may further include a general purpose user interface (U.I.) 118 which authorized non-admin users may log into to privately and securely access facility-related information, for example, as might be prepared by the system administrator and/or prepared autonomously by a cloud-based diagnostics engine 128 and report generator 130, for example, in the form of charts, tables, graphs, etc. This information may be accessed, for example, by the user logging into an email or web server 132 located within the cloud-based computing platform 102 (via the private and secure link 106, for example).

In one embodiment of the invention the general purpose U.I. 118 is further configured to run a local (or web-based) application that allows a user (non-admin user or system administrator) to enter a single-line drawing (SLD) of the IoT-enabled industrial facility 104. With the SLD made available to the cloud-based computing platform 102, the cloud-based computing platform 102 is then able to, among other things: construct a topological map of the facility 104, showing electrical and mechanical equipment, as well as placement of IoT nodes 110 and their node-to-node relationships within the facility 104; perform simulations of the facility 104 under various conditions; and, as will be described in detail below, perform pinpointing and tracing operations that allow the cloud-based computing platform 102 to quickly, reliably, and accurately determine the exact physical location in the facility 104 that an event has occurred, or is occurring, as well as the root cause of the event, including any machines and/or electrical equipment within the facility identified by or associated with the event.

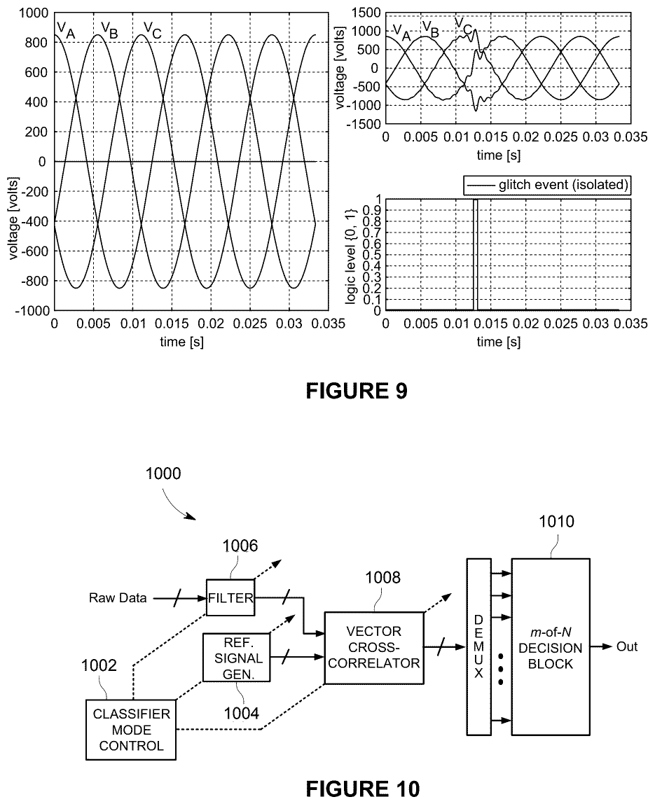

In accordance with one embodiment of the invention, data captures that have been uploaded to the cloud-based computing platform 102 from the IoT nodes 110 are directed to an event identifier 134. The event identifier 134 comprises a computer program designed to run on one or cloud computers in the cloud-based computing platform 102, and that provides the one or more cloud computers the ability to identify “events” contained in the data captures received from the IoT nodes 110. Events include voltage and current transients, e.g., electrical “signatures,” that are peculiar to, or symptomatic of, the operation and malfunction of the machines and other electrical infrastructure within the IoT-enabled industrial facility 104, such as motor starts and stops, rises, falls, imbalances, and single-phasing phenomena. Events may also comprise voltage and current data, characteristic or representative of one or more voltage and/or current waveforms, that deviates from ideal, normal, or expected values and is indicative or predictive of failure, imminent failure, or potential failure, such as, for example, ground faults, phase-to-phase shorts, phase-to-ground shorts, under-voltage and over-voltage conditions, switchgear malfunctions, and machine-related malfunctions, such as those relating to the operation and malfunction of gearboxes, bearings, rotor bars, drive belts, etc. In fact, and for purposes of this disclosure, events are considered to comprise any characteristic or change in voltage and/or current represented in the data captures that is/are of diagnostic or predictive value. The graph in the top-right portion of FIG. 9 shows, for example, a contactor bounce event associated with the switchgear of a three-phase induction motor. The ripple or “glitch” present in all three voltage waveform phases is seen to deviate from the three normal or expected waveforms shown in the graph on the left side of FIG. 9, and the timing diagram in the lower-right portion of FIG. 9 reveals both when the contactor bounce event begins and its duration.

Reference information defining and classifying the many possible event types is stored in a cloud-based storage device within the cloud-based computing platform 102, and is referred to in FIG. 1 and throughout this disclosure as the “event library 136.” The event library 136 is accessible by the one or more cloud computers as it/they execute the event identifier 134 program and scan data captures reported by the IoT nodes 110 for events. FIG. 10 illustrates algorithmically the salient components of the event identifier 134. As shown, the event identifier algorithm 1000 comprises a classifier mode control block 1002, a reference signal generator 1004, a filter 1006, a vector cross-correlator 1008, and an m-of-N decoder 1010 (i.e., decision block 1010). The classifier mode control block 1002 selects the type of event for scanning, and also sets the time scale appropriate for the given analysis: high-resolution (sample-by-sample) or longer time-scale (e.g., multi-millisecond or more widely spaced samples). The reference signal generator 1004 sets the appropriate reference signal(s) that embody the event to be identified. During operation, the filter 1006 pre-processes the raw data for noise removal or frequency selection to improve accuracy and help increase the true positive rate while minimizing the false positive rate. The vector cross-correlator 1008 correlates the reference signal(s) with a correlation function, in an effort to maximize correlation between the raw data and the reference signal(s), and thereby allow the event, if present in the input raw data, to be identified. This process may be performed on multiple parallel channels simultaneously, for example, on all three voltage and current phases of one or more data captures produced by a given sensor module 804.

In one embodiment of the invention the event identifier 134 is configurable in one of two modes: “verification” and “search.” In verification mode, the event identifier 134 selects a single type of event (e.g., contactor bounce, motor start, etc.), to confirm the presence of that event in multiple channels of disparate raw data, and the output of the m-of-N decoder 1010 indicates which channel of raw data contains the event in question. In search mode, the event identifier 134 uses a single source of raw data (e.g., a unique current signal) and copies it to multiple input channels, and multiple references corresponding to multiple types of events are applied. The output of the m-of-N decoder 1010 then indicates (i.e., identifies) which type of event is contained in the raw data input, based on correlation calculations performed by the vector cross-correlator 1008.

As discussed above, the local admin portal 116 and a remote admin portal 122 provide the system administrator the ability to access and interpret event-related data and alert the facility supervisor of any recognized problems or potential problems. These same access, data interpretation, event detection capabilities are also performed by the diagnostics engine 128, and in most cases more reliably, accurately, and rapidly than the human system administrator can. Like the event identifier 134, the diagnostics engine 128 comprises a cloud-based computer program that runs on one or more cloud computers in the cloud-based computing platform 102. By analyzing data captures identified by the event identifier 134, consulting event-related information stored in the event library 136 and N²CESaR database 138 (described in more detail below), the one or more cloud computers, as directed by the diagnostics engine 128, is/are able to diagnose, in real time, problems or potential problems relating to the operation of the IoT nodes 110 (802), sensor modules 804, and electrical machinery and equipment deployed within the IoT-enabled industrial facility 104. Analyzing data captures and diagnosing problems and potential problems is performed autonomously (i.e., without the need for any human participation or human interaction) and continuously, and is superior in most respects to relying on a human system administrator to monitor, analyze, and diagnose events. In fact, there are some types of events that are not even susceptible to human analysis and diagnosis, in other words, that can only be successfully analyzed and diagnosed through use of the one or more cloud computers and the diagnostics engine 128. The real-time diagnostic capability of the one or more cloud computers, as directed by the diagnostic engine 128, is also superior since it allows the facility supervisor to be notified of any diagnosed problems or potential problems much more rapidly than if it was necessary to rely solely on the human system administrator to do the same. Alerts and notifications from the cloud-based computing platform 102 to the system administrator and facility supervisor may be conveyed in any form, for example, via text message or a phone call generated by a cloud-based alert generator 140. Additionally or alternatively reports can be generated by the report generator 130 and sent to the facility supervisor and/or the system administrator via the email or web server 132. In one embodiment of the invention, diagnostic information generated by the one or more cloud computers and diagnostic engine 128 is also directed to and used to schedule or update a predictive maintenance schedule in a predictive maintenance module 142 and/or directed to an artificial intelligence (A.I.) and machine learning module 144, which utilizes the diagnostic information to improve the system's detection, prediction, and preventative maintenance capabilities, and to improve the one or more cloud computer's and diagnostic engine's 128's accuracy at diagnosing and predicting equipment failures within the IoT-enabled industrial facility 104.

It should be mentioned that because the event identifier 134 is also involved in diagnosing events (i.e., in addition to the diagnostics engine 128), it can be considered to be a part of the diagnostics engine 128, rather than as a separate program distinct from the diagnostics engine 128 (as depicted in FIG. 1). However, it is also important to recognize and understand that some types of events require no further diagnosis, other than to be identified, before a conclusion can be drawn that there is in fact a problem or potential problem within the facility 104 requiring the system administrator and/or facility supervisor to be alerted or notified. For example, events indicative of ground faults, phase-to-phase shorts, phase-to-ground shorts (all of which may be categorized as members of a “short circuit” class within the event library 136), and events indicative of gearbox failures, bearing failures, rotor bar failures, and single-phasing (all of which may be categorized as members of a “motor failure” class within the event library 136) require no further diagnosis. On the other hand, there are other types of events that require further diagnosis, before the one or more cloud computers and diagnostics engine 128 can properly conclude that a problem is present, impending, or predicted to occur sometime in the future. This further diagnosis may, and often does, require analyzing multiple data captures to determine whether a given event will continue to persist or reoccur and whether the persistence or reoccurrence is a problem that should be brought to the attention of the system administrator and/or facility supervisor. For example, an over-voltage condition identified by the event identifier 134 may not be of concern if it happens just once and briefly during a single data capture but may be considered problematic if the one or more cloud computers and diagnostics engine 128 determine that the event continues to persist or reoccurs in subsequent data captures. Or, as another example, events analyzed in the frequency domain, such as those identifying the vibration and harmonic content associated with the functioning of a motor belt or motor bearing, might not be of concern unless the one or more cloud computers and diagnostics engine 128 diagnose a harmonic trend over multiple data captures that is indicative or predictive of, say, an imminent or impending motor-belt or motor-bearing failure.

It should also be mentioned that although the event identifier 134 and diagnostic engine 128 are valuable tools for both identifying and diagnosing events, identifying and diagnosing events relating to the operation and malfunction of a particular machine can be challenging if that machine operates according to a very short work cycle or operates only intermittently or occasionally for short durations of time. In such circumstances, the ability to identify events may not be possible, whether the data is being analyzed in the time domain (because the work-cycle-data is too brief) or in the frequency domain (due to insufficient frequency resolution, because of insufficient available data). To help overcome this problem, in one embodiment of the present invention, and with the aid of the work cycle detector 124, a plurality of work cycle data fragments characterizing the operation of a machine having a short work cycle are extracted from one or more work cycles in one or more data captures, and then combined into a single autocorrelation estimate, for example, using an autoregressive moving-average estimation. The resulting power spectrum of the autocorrelated estimate has an improved spectral resolution, greater than which could be achieved by sole use of a fast Fourier transform (FFT), for example, thereby increasing the ability to identify and diagnose events (in the frequency domain, in this example). To address this same problem, in another embodiment of the invention IoT controllers associated with machines that operate according to short work cycles are alternatively (or also) configured to control their respective machines so that they temporarily increase their work cycles. Temporarily increasing the work cycles results in more data being available for analysis and consequently an increased ability to identify and diagnose events relating to the operation and malfunction of the associated short-work-cycle machines.

As further illustrated in FIG. 1, the cloud-based computing platform 102 further comprises a node synch agent 146, concurrence program 148, conflict resolution program 150, and pinpointing program 152, which collectively provide the cloud-based computing platform 102 the ability to pinpoint the exact location within the IoT-enabled industrial facility 104 that an event originated, as well as the root cause of the event such as, for example, a broken or malfunctioning motor or broken or failing electrical device. Without these capabilities, pinpointing the origin of events and identifying their root causes is complicated, and in many instances impossible, considering that events will often propagate along multiple, and sometimes lengthy, electrical paths within the industrial facility's 104's electrical distribution network, and considering that a given event will often be detected by multiple IoT nodes 110 dispersed across a large area of the facility 104. The ability to pinpoint events and determine their root causes is further complicated by the fact that there can never be 100% certainty that all IoT nodes 110 within the facility 104 that should detect a given event do in fact properly detect the event and by the fact that there can never be 100% certainty that all IoT nodes 110 within the facility 104 that should not detect the event do in fact not improperly detect the event.

An IoT node 110 (802) that failed to detect an event, even though it should have, may be due to it not being connected properly to its associated sensor module 804, for example, or due to the sensor module 804 not being properly connected to the machine or electrical device the IoT node 110 is supposed to be monitoring. This “false negative” could also be due to faulty or malfunctioning node hardware or software. These same and other factors might result in an IoT node 110 detecting an event, even though it should not have (“false positive”). The methods by which these false positives and false negatives are dealt with, in order to provide the IIoT system 100 the ability to reliably, accurately, and rapidly pinpoint events and determine their root causes will now be described in detail.

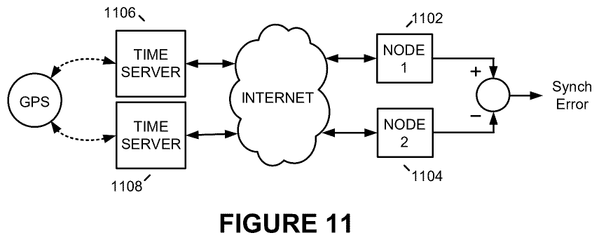

First, based on topological information of the industrial facility 104, such as may be obtained from the facility's SLD, and following instructions specified by the node synch agent 146, one or more cloud computers perform(s) a pairwise synchronization of two selected IoT nodes 110. As conceptually in FIG. 11, this pairwise synchronization process involves a select pair of IoT nodes (first and second IoT nodes 1102 and 1104 in FIG. 11) requesting time references for their respective clocks from GPS-based time servers 1106 and 1108, via the Internet, for example. Depending on the packet-switching delays inherent to modern Internet-based communications, the requests are typically granted within 1 ms of each other, resulting in a pairwise synchronization of IoT nodes 1102 and 1104 of around 1 ms precision.

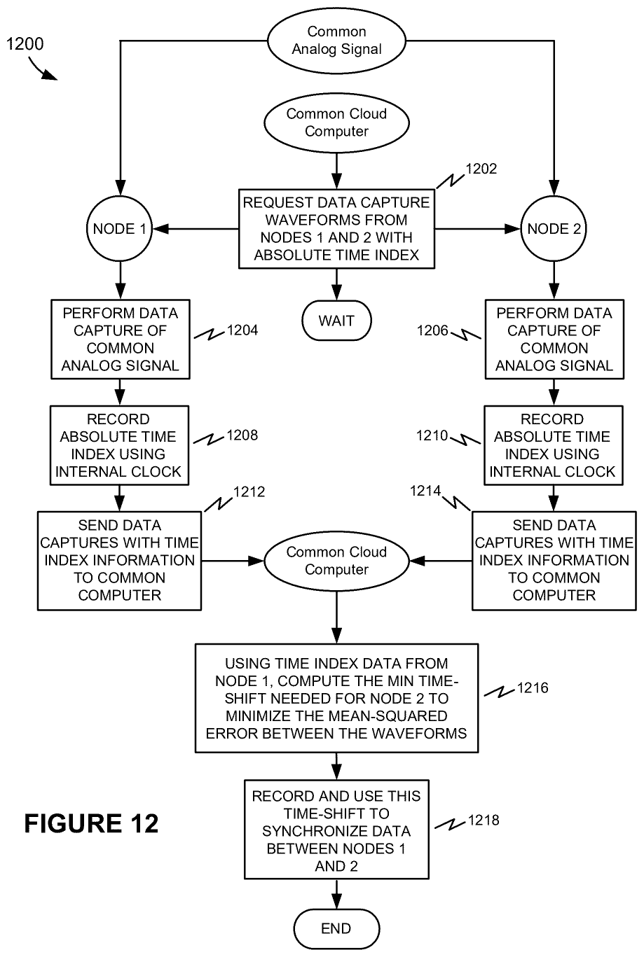

Because the ability to detect and identify some types of events can require even greater precision, the node synch agent 146 is designed so that a common computer (e.g., a common cloud computer) can synchronize the nodes 1102 and 1104 to sub-millisecond precision. (Note: This more precise synchronization process may be alternatively performed by a local synch server 120 within the IoT-enabled industrial facility 104, as indicated in FIG. 1, in other words, rather than in the cloud, in which case the local synch server 120 would serve as the “common computer.”) FIG. 12 is a flowchart illustrating the method 1200 the common computer performs to facilitate this more precise synchronization process. First, at step 1202 the common computer requests data captures from both IoT nodes 1102 and 1104 (referred to as “Node 1” and “Node 2” in the flowchart), each with an absolute time index. Responding to the requests, at steps 1204 and 1206, the two IoT nodes 1102 and 1104 independently perform data captures of a common analog signal, and at steps 1208 and 1210 record their data capture in their local memories 808, along with an absolute time index set by their own respective internal clocks. Next, at steps 1212 and 1214, each of the two IoT nodes 1102 and 1104 communicates its data capture and associated time index to the common computer. Using the time index data from one of the two IoT nodes 1102 and 1104, at step 1216 the common computer then computes the minimum time-shift needed to minimize the mean-squared error between the two data captures (referred to as the “synch error” in FIG. 1). Finally, at step 1218 the common computer uses the synch error to synchronize the two IoT nodes 1102 and 1104 and thereby realize a sub-millisecond and sub-sample-period synchronization between the two IoT nodes 1102 and 1104.

Using the same pairwise synchronization process described above, the remaining IoT nodes 110 within the industrial facility 104 can be synchronized to a common reference. For example, suppose a given facility 104 has nodes labeled N₁, N₂, . . . ,Nₘ, and the first pair of IoT nodes that is synchronized is nodes N₁ and N₂ (corresponding to the two IoT nodes 1102 and 1104 above). Each remaining IoT node, namely N₃, N₄, . . . ,Nₘ, can be, in turn, synchronized to node N₁, so that all IoT nodes are synchronized, where synch-error corrections are applied only to IoT nodes other than IoT node N₁.

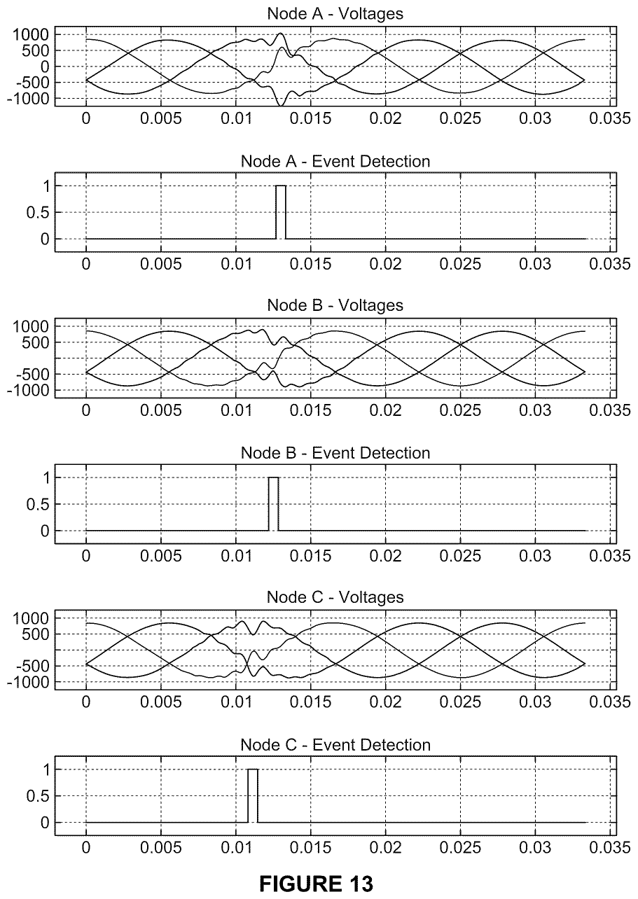

One significant and desirable side effect of completing the above-described synchronization process is that it effectively transforms the cloud-based computing platform 102 into a multi-point virtual oscilloscope for the IoT-enabled industrial facility 104, allowing multiple real-time graphs to be viewed on a common time axis (for example on displays of the local and remote admin portals 116 and 122), for bandlimited signals up to one-half the sampling rate. FIG. 13 is a timing diagram illustrating this multi-point virtual oscilloscope capability. Three-phase voltage waveforms formed from multiple, synchronized data captures are shown for three synchronized nodes, “node A,” “node B,” and “node C.” Because the three nodes are synchronized, the glitch event is observable in a common “window” of time, thereby allowing the event not only to be identified but allowing its association with all three nodes to also be identified concurrently, within the same common event window.

The node synch error produced from the synchronization process is stored in a Node-Node Connection, Event-Statistics and Record (N²CESaR) database 138, and updated from time to time in order to maintain accurate synchronization among the IoT nodes 110. Preferably, the node synch error and other node-related information are stored in relational-database-format, with the other node-related information, including: the status of an IoT node 110 with respect to every other IoT node 110 within the IoT-enabled industrial facility 104 as being either coincident or dissociated; IoT node information, such as nameplate data and physical location of each IoT node 110 within the facility's SLD; statistical estimates for each IoT node 110 across all possible event categories, including, estimates of true positive, false negative, true negative, and false positive detection and reporting rates (for all types and classes of events); node events (within a defined event window) for each IoT node 110, along with synchronized timestamps corresponding to the onset and duration of each node event; and information relating to the intensity of events experienced by each IoT node 110. The N²CESAR database 138 may be configured and stored within one or more storage devices located within the cloud-based computing platform 102 (as indicated in FIG. 1), locally on a centralized server within the facility 104, or in a distributed manner using a blockchain implementation, either among the IoT nodes 110 themselves or external to the IoT-enabled industrial facility 104.

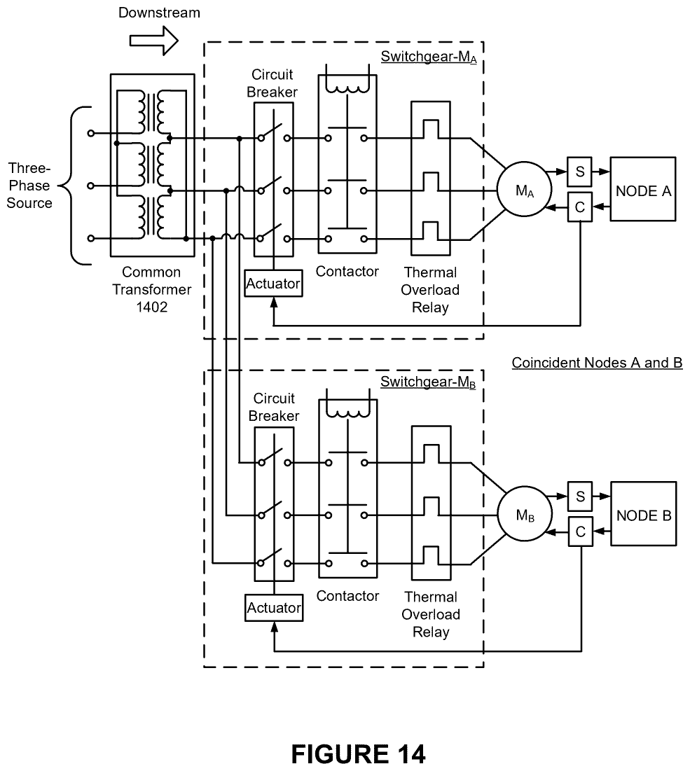

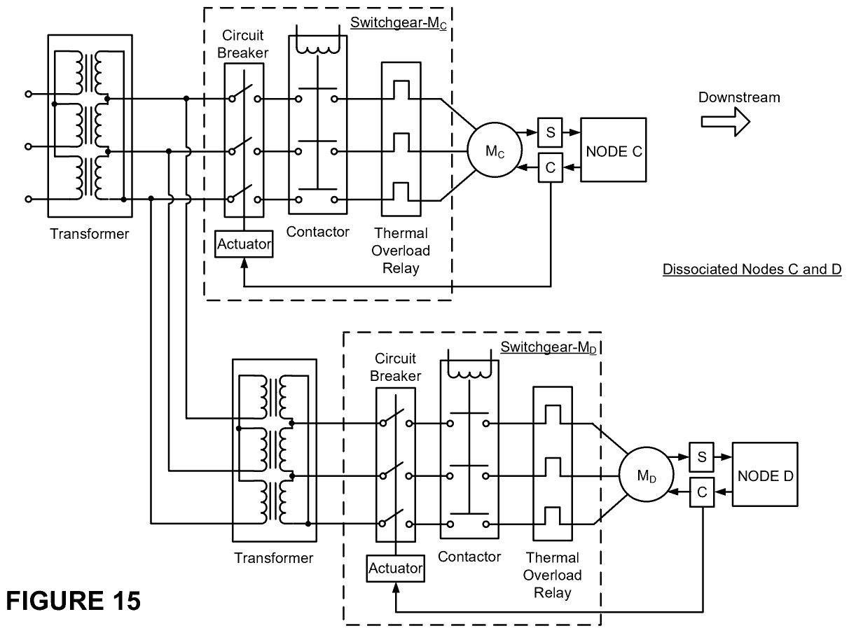

After the IoT nodes 110 have been successfully synchronized, it is then possible for one or more cloud computers to “temporally correlate” events captured by the IoT nodes 110. In accordance with one embodiment of the present invention, the temporal correlation of an event is accomplished by configuring the one or more cloud computers to execute the concurrence program 148. Executing the concurrence program 148, the one or more cloud computers determine which IoT nodes 110 detected a given event in a given event window and thereby establish(es) valuable localization information concerning the origin of the event. Important objectives involved in executing the concurrence program 148 include identifying pairs of IT nodes that has/have concurrently captured the event and identifying pairs of IoT nodes 110 that are “coincident” or “dissociated”. (Note: Information concerning whether pairs of IoT nodes 110 are coincident or dissociated can be obtained, for example, from an SLD of the IoT-enabled industrial facility 104.) A pair of IoT nodes is considered to be “coincident” if the machine(s) or electrical device(s) they are connected to (via their sensor and control modules) share a common source transformer 1402 and operate at the same voltage level, as nodes A and B do in FIG. 14, for example. In contrast, a pair of IoT nodes is considered to be “dissociated” if the two IoT nodes are connected to different machines located downstream/upstream from each other and to distinct transformers, as nodes C and D are in FIG. 15. (Note: Because the IoT nodes 110 must be synchronized before temporally correlating an event can successfully ensue, the synchronization of nodes 110 process can be considered to be, though not necessarily, a part of the overall temporal correlation of events process, in other words, rather than as a separate independent process. It should also be noted that it is possible for more than two IoT nodes to be coincident; so when executing the concurrence program 148, the one or more cloud computers is/are capable of identifying any number of IoT nodes that happen to be coincident, i.e., any two or more not necessarily just pairs of coincident nodes.)

Assuming that an event-capturing pair of IoT nodes is coincident, like nodes A and B in are in FIG. 14, and assuming that the two nodes are properly configured with no inherent flaws in software or hardware and each node's true positive and true negative rates are both 1, three cases can be identified which help to localize the event: 1) case 1_coincident: node A detects the event but node B does not, the outcome of which means the event is associated with equipment MA; 2) case 2_coincident: node B detects the event but node A does not, the outcome of which means the event is associated with equipment MB; and case 3_coincident: both node A and node B register the (synchronized) event, the outcome of which means the event is at the common source transformer 1402 or upstream. In contrast, if event-capturing pair of IoT nodes is dissociated, like Nodes C and D are in FIG. 15, and assuming again that the two nodes C and D are properly configured with no inherent flaws in software or hardware and their true positive and true negative rates are both 1, three more cases can be identified: 4) case 1_dissociated: node C detects the event but node D does not, the outcome of which means the event is associated with or upstream with respect to equipment Mc but downstream with respect to equipment M_{D}; 5) case 2_dissociated: node D detects the event but node C does not, the outcome of which means the event is associated with or upstream with respect equipment M_{D}; and 6) case 3_dissociated: both node C and node D register the (synchronized) event, the outcome of which means the event is associated with or upstream with respect to equipment M_{D}.

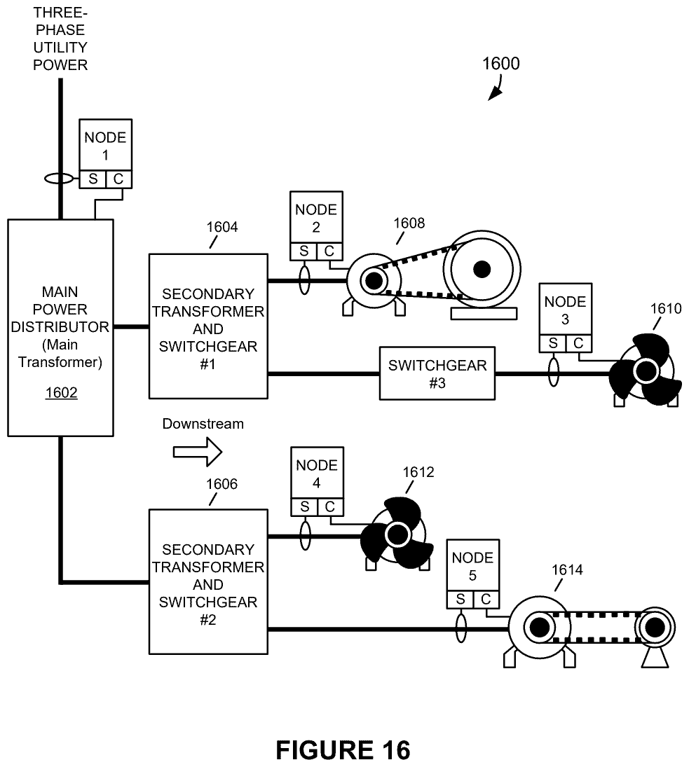

By aggregating the localization information obtained from identifying all pairwise groups of event-detecting nodes, including whether each event-detecting node pair is coincident or dissociated, the cloud-based computing platform 102 can then proceed to localize the given event in a global sense. Consider the simplified multi-node network 1600 depicted in FIG. 16, and suppose the event of interest originates in the secondary winding of the main transformer 1602. A first node pair comprised of nodes 2 and 3, which is coincident by virtue of the fact that associated machines 1608 and 1610 share a common transformer 1604, and a second node pair comprised of nodes 4 and 5, which is also coincident by virtue of the fact that associated machines 1612 and 1614 share a common transformer 1606, should both detect the event as occurring at or upstream from their respective transformers 1604 and 1606. Meanwhile, assuming that coupling from the main transformer's 1602's secondary winding to its primary winding is negligible, node 1, which is dissociated with respect each of nodes 2-5, should not detect the event, since it is located upstream from the main transformer 1602 and connected to a separate transformer, specifically, to the primary winding of the main transformer 1602. As a result, the event can be said to be localized within the facility 104 and associated with the main transformer 1602.

In the example just described, it was assumed that the true positive and true negative detection rates of each IoT node 110 are 1, in other words, it was assumed that the false positive and false negative detection rates of each IoT node 110 are both 0. However, there are various reasons why these assumptions can be inaccurate and can lead to errors in localizing events. In most circumstances, each IoT node 110 will properly detect an event when it should detect the event (“true positive” (TP)), and each IoT node 110 will properly not detect an event when it should not detect the event (“true negative” (TN)). However, there are instances, unfortunately, when an IoT node 110 fails to detect an event, even when it should (“false negative” (FN)), and there are instances (also unfortunate) when an IoT node 110 detects an event, even though it should not have (“false positive” (FP)). There are various reasons why these mistakes occur. As alluded to above, an IoT node's 110's (802's) mistake in detecting an event could be due to the IoT node 110 (802) not being properly connected to its associated sensor module 804, or its sensor module 804 not being properly connected to the machine or electrical device the IoT node 110 is supposed to be monitoring. Or a mistake in detecting the event could be due to faulty or malfunctioning node hardware or software. The assumption that the TP and TN detection rates of all IoT nodes 110 in the facility are 1, and that the FP and FN detection rates of all IoT nodes 110 in the facility are 0, is therefore not accurate, and if the true TP, TN, FP and FN detection rates are not properly taken into consideration, any effort to localize any given event can lead to error.

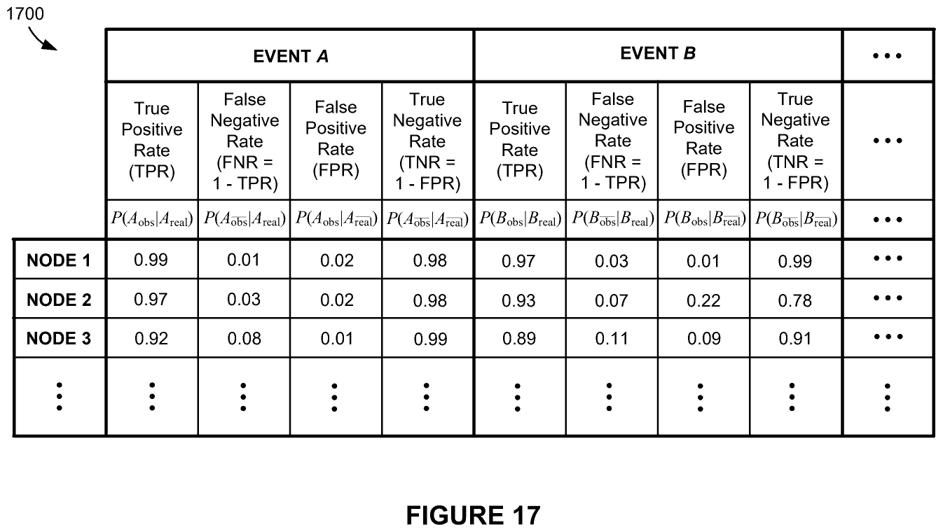

Whenever two IoT nodes 110 are coincident, for example, detection mistakes lead to conflicts as to whether a given event actually occurred. For example, for a given type of event, if the TP detection rate of node 4 in the simplified multi-node network 1600 in FIG. 16 is high, say, greater than 0.5, and the FN detection rate of node 5 is also high, say, greater than 0.5, when an event of the given type occurs, node 4 will most likely detect the event, by virtue of its high TP detection rate, but node 5 will most likely fail to detect the event, even though the event actually occurred, because of its high FN detection rate (i.e., because of its low TP detection rate). To resolve this conflict, and to greatly improve the accuracy and reliability of localizing events, in accordance with one embodiment of the present invention, one or more cloud computers in the cloud-based computing platform 102 is/are configured to execute the conflict resolution program 150. The algorithm upon which the conflict resolution program 150 is based takes into account probability estimates of each of the IoT nodes 110 in the IoT-enabled industrial facility 104, including each IoT node's 110's TP, FN, FP, and TN detection rates. These rates (i.e., “statistics” or “probabilities”) are populated in an event-statistics table 1700 within the N²CESaR database 138 (see FIG. 17), and accessed by the one or more cloud computers as it/they execute the conflict resolution program 150. Upon executing the conflict resolution program 150, the one or more cloud computers then make a determinative decision as to whether a given event E has occurred in circumstances where two or more coincident nodes disagree. In one embodiment of the invention the algorithm upon which the conflict resolution program 150 is based employs a weighted sum function σ and a nonlinear threshold function, sgn ( ) i.e., signum function. According to that approach: 1) for a set of coincident nodes {n₁, n₂, . . . ,nₘ}, where m is an integer greater than one; 2) a first subset of those nodes {n₁, n₂, . . . ,nₖ} that registers an event E, and a second subset {nₖ₊₁, nₖ₊₂, . . . , nₘ} that does not register the same event E; and 3) for some integer k in the half-closed interval (1, M], the weighted sum σ is computed as follows:

$$σ = {\sum }_{i = 1}^{k} {P}_{i} ( {E}_{obs} \vert {E}_{real} ) - {\sum }_{i = k + 1}^{M} {P}_{i} ( {E}_{\overline{obs}} \vert {E}_{\overline{real}} ) ,$$

where Pᵢ( ) denotes the probability associated with node nᵢ, the subscript “obs” denotes an event E that was observed by one or more IoT nodes 110, even though the event did not necessarily actually occur, and the subscript “real” denotes the actually-occurring event, though not necessarily observed by one or more IoT nodes 110. Applying the sgn ( ) nonlinearity, a determiner y is then computed based on the weighted sum σ:

$$y = sgn ( σ ) = \{ 1 , σ \geq 0 ; 0 , σ < 0 ,$$

and the event E is determined to have occurred if y=1 and, alternatively, not to have occurred if y=0. Because the event detection rates of each IoT node 110 can, and often will, change over time, they are periodically updated in the event-statistics table 1700 as the IIoT system 100 operates. Additionally, because the true TP, TN, FP and FN detection rates will also typically depend on the type of event involved, best estimates for the true values of TP, TN, FP and FN are kept for each event type (as indicated in FIG. 17).

It should be mentioned that errors in localizing events, including conflicts between coincident nodes, can also occur when IoT nodes 110 make mistakes in reporting—in other words, not just when detecting events. These reporting mistakes can be caused by faulty or malfunctioning node hardware or software, network-related problems, electrical interference within the facility 104, or in fact any internal or external influence that adversely affects the IoT nodes' 110s′ ability to properly report events. Additionally, the reporting mistakes can be made regardless of whether the IoT nodes 110 detect the events, in other words, the reporting rates (probabilities) of the IoT nodes 110 are independent of their detection rates. Therefore, to further improve the accuracy of localizing events, in one embodiment of the invention the TP, FN, FP and TN detection rates and the TP, FN, FP and TN reporting rates of the IoT nodes 110 are both taken into consideration when performing the concurrence and conflict resolution computations described above, including using a weighted sum and signum function to resolve reporting conflicts, similar to how detection conflicts are resolved. The TP, FN, FP and TN reporting rates can also be stored in the event-statistics table 1700, effectively making it an event-statistics multi-dimensional array.

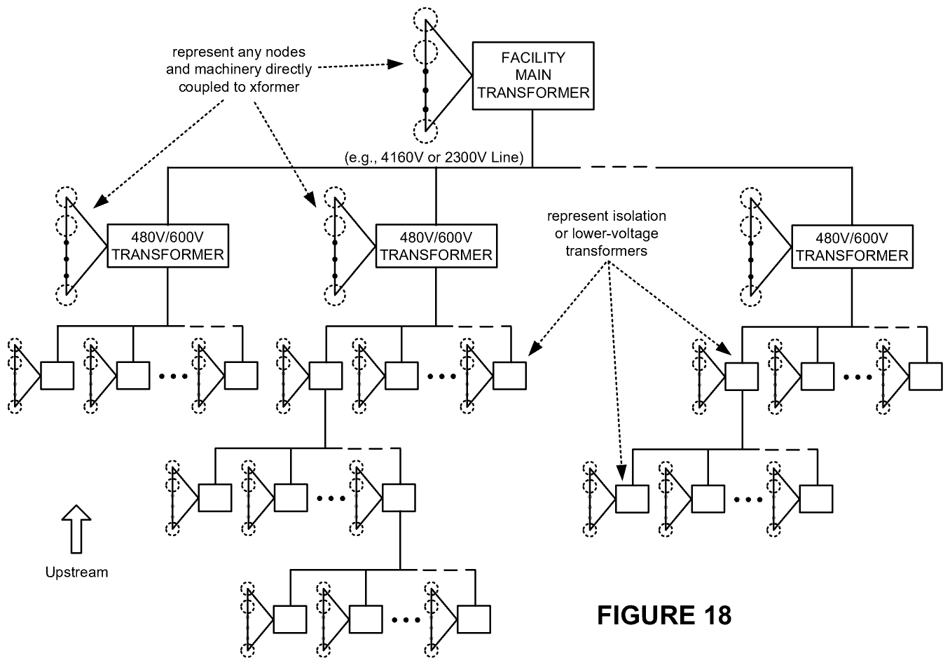

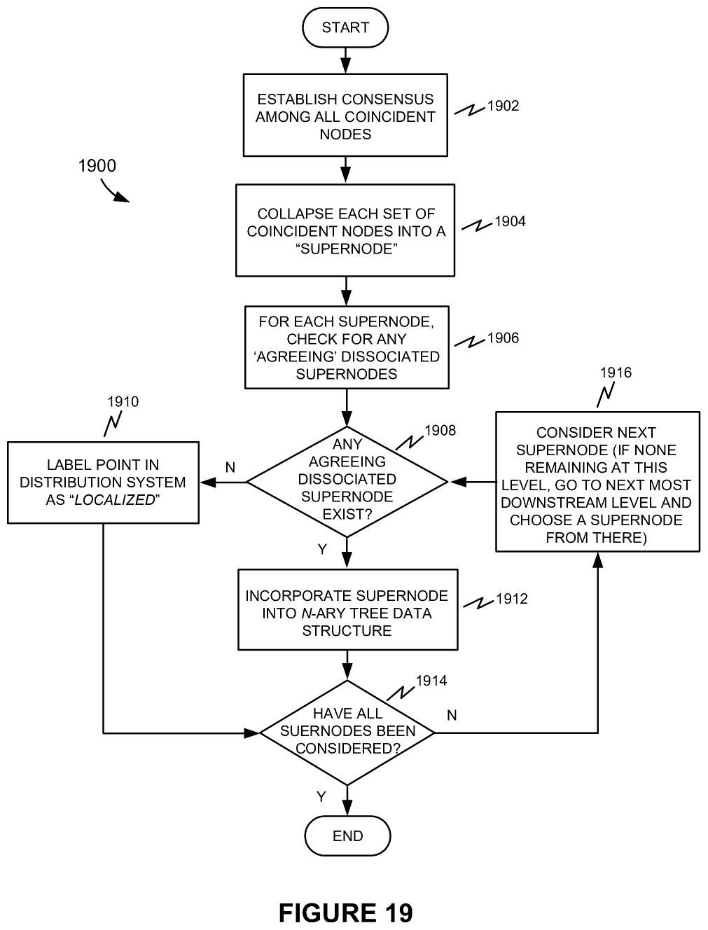

After the one or more cloud computers have temporally correlated a given event (by executing the concurrence program 148 and resolving all conflicts among event-detecting coincident nodes in accordance with the conflict resolution program 150), the exact physical location within the industrial facility 104 that an event originated can then be determined, as well as the root cause of the event. In accordance with one embodiment of the present invention, this “spatial correlation” of events process, i.e., “pinpointing” process, is performed by configuring one or more cloud computers in the cloud-based computing platform 102 to execute the pinpointing program 152. The algorithm upon which the pinpointing program 152 is based relies on a data structure having a 1:1 correspondence with the topological layout of the facility 104 (as determined from a SLD of the industrial facility 104, for example), as illustrated in FIG. 18, and proceeds in a given “event window” (a block of time reserved for event analysis), for a given event E, as illustrated in the flowchart presented in FIG. 19. In the first step 1902 of the pinpointing method 1900, using the concurrence and conflict resolution programs 148 and 150 described above, consensus is established amongst all event-detecting coincident IoT nodes 110 within the facility 104, in other words, all conflicts among all event-detecting coincident IoT nodes 110 within the facility are resolved. At step 1904, each set of coincident nodes is then collapsed into a single “supernode,” each supernode reflecting the consensus calculation performed in prior step 1902. Next, at step 1906, a check is made for each supernode as to whether there are any “agreeing” dissociated upstream supernodes in the data structure. If at decision 1908 it is determined that no “agreeing” dissociated upstream supernode exists, at step 1910 that specific point in the data structure is labeled as “localized,” and by virtue of the 1:1 correspondence with the SLD of the facility 104 the exact physical location of the event within the facility 104 is effectively determined. If the pinpointed event is indicative or predictive of an equipment related failure or malfunction, the machine(s) and/or electrical equipment that caused their associated IoT node(s) 110 to detect and report the event, are also identified as being the probable root cause of the event. If, on the other hand, it is determined at decision 1908 that an “agreeing” dissociated supernode does exist, at step 1912 the identified agreeing dissociated supernode is incorporated into the data structure (for purposes of “tracing,” as discussed below). Then, at decision 1914, a query is made as to whether all supernodes have been considered. If “yes,” the method 1900 ends. Otherwise (“no” at decision 1914), at step 1916 the next supernode is considered, traversing to the next level in the data structure if no supernodes remain in the current level, and steps 1912 and 1916 are repeated until no “agreeing” dissociated upstream supernode exists and the exact physical location within the facility 104 that the event originated is ultimately determined at step 1910.

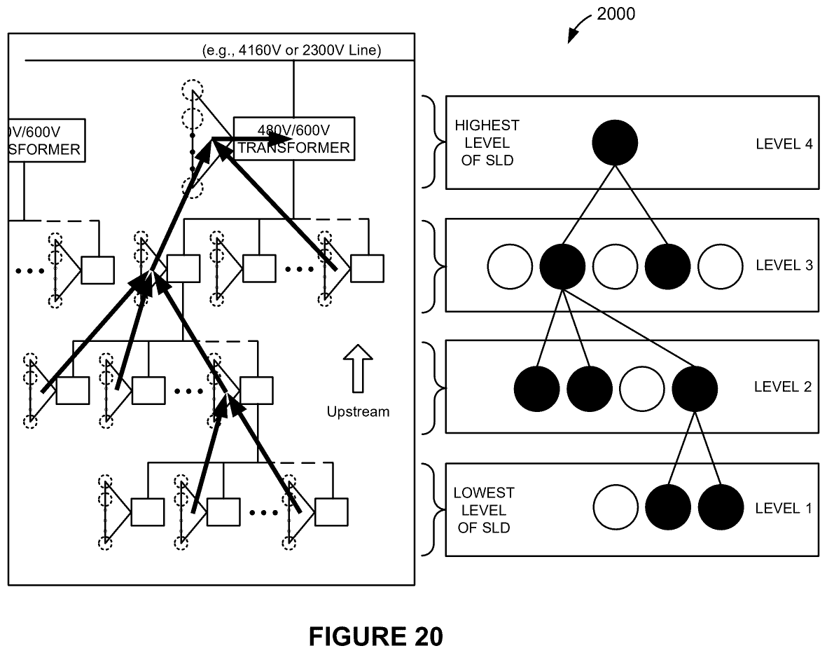

By establishing “links” between supernodes, an event can be “traced,” starting from the lowest level of the N-ary data structure tree (and, by virtue of its 1:1 correspondence to the facility's 104's SLD) all the way to its origin (which corresponds to the highest level in the data structure at which no “agreeing” dissociated upstream supernodes remain, whether at that level or any higher level, as determined by a “no” at decision 1908 of the pinpointing method 1900). Tracing thus allows the extent of propagation of the event to be determined. Modifying the N-ary tree data structure so that it includes these links provides another way of conceptualizing how the pinpointing method 1900 pinpoints the exact physical location of an event within the IoT-enabled industrial facility 104. As illustrated in FIG. 20, for any supernode for which an “agreeing” dissociated supernode exists (indicated by the filled (black) circle supernodes in the drawing on the right-half side of FIG. 20), a link is established. Each link is denoted by an arrow symbol, with the direction of the arrow pointing in the upstream direction of the electrical distribution network within the facility 104. (Note: No links are established (no arrows are drawn) from or to those supernodes for which the signum function sgn ( ) of the conflict resolution program yielded a y=0 (indicated by the unfilled (white) circles.) Starting from the lowest level of the data structure and moving upstream, the tracing method, as executed by one or more cloud computers in the cloud-based computing platform 102, proceeds as follows. First, for any two links of the same length that share a common head but not a tail, the one or more cloud computers combine the two links into a single link of the same length. If a third link happens to share the same head position as the other two links, the two shortest links among the three is deleted; otherwise, if there is only one short link among the three, the short link is deleted and the first step is repeated so that just a single link from among the original three remains. Then, for any link having a head connected to the tail of another link, the one or more cloud computers create a new link from the downstream tail to the upstream head. The above procedure is repeated until there is no change in the directional links, at which point the heads of all remaining links (arrows) identify the physical origin of the event.

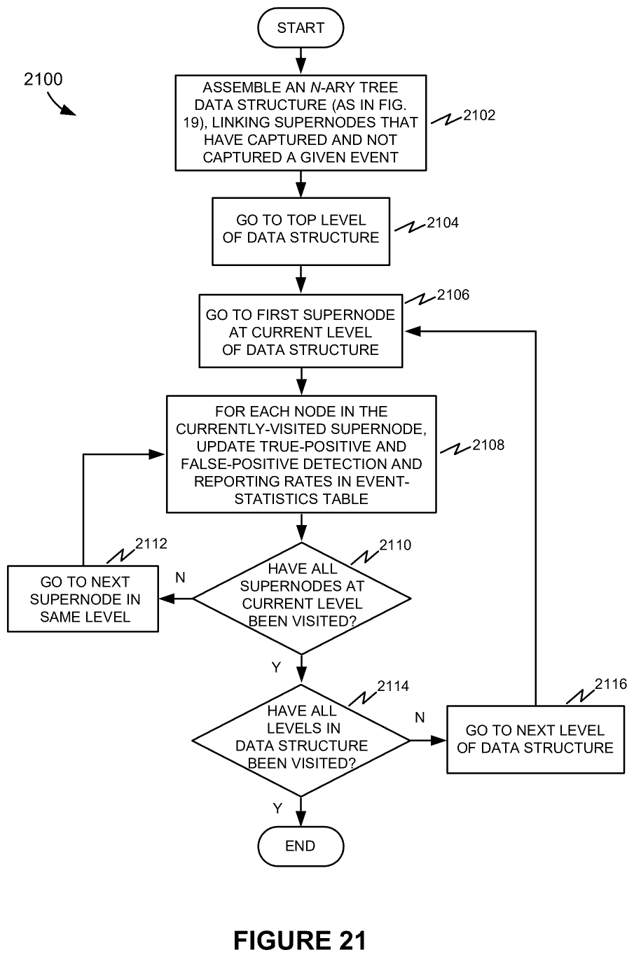

In addition to being able to pinpoint the exact physical origin of an event within the IoT-enabled industrial facility 104, tracing affords the cloud-based computing platform 102 the ability to update the TP, TN, FP and FN detection rates (of the IoT nodes 110 in the event-statistics table 1700, for each concurrently detected event. This aspect of the tracing algorithm, which may be referred to as the event-statistics updating method 2100, is illustrated in the flowchart in FIG. 21. At first step 2102 in the method 2100, one or more cloud computers retrieve the N-ary tree data structure that was constructed during pinpointing (see FIG. 19 above), or an identical N-ary tree data structure 2000 is assembled, similar to as illustrated in FIG. 20, linking supernodes that concurrently detected the given event. At step 2104, the method 2100 goes to the top (i.e., highest) level of the data structure, e.g., “Level 4” in the exemplary data structure 2000 depicted in FIG. 20, and then visits the first supernode in that currently-visited level. Next, at step 2106, the TP and FP detection rates for each IoT 110 node that is a member of the currently-visited supernode are updated in the event-statistics table 1600, along with their false negative (FN=1-TP) and true negative (TN=1-FP) detection rates. At decision 2110 a query is made as to whether all supernodes in the current level of the data structure 2000 have been visited. If they have not (“no” at step 2112), the next supernode in the same level of the data structure is visited, and step 2108 is repeated for each supernode in that level until the TP, FN, FP and TN detection rates of all nodes 110 have been updated in the event-statistics table 1600. After all supernodes have been visited at the current level, a “yes” is produced at decision 2110, and decision 2114 then determines whether all levels in the data structure have been visited. If they have (“yes” at decision 2114), the method 2100 is complete and ends. On the other hand, if not all levels have yet been visited, at step 2116 the method 2100 moves down to the next level in the data structure and then branches back to step 2106. Step 2106, step 2108 and decision 2110 are then repeated in the same manner as described above, until at decision 2114 it is determined that all levels in the data structure have been visited and all TP, FN, FP and TN detection rates for all IoT 110 nodes have been updated in the event-statistics table 1700.

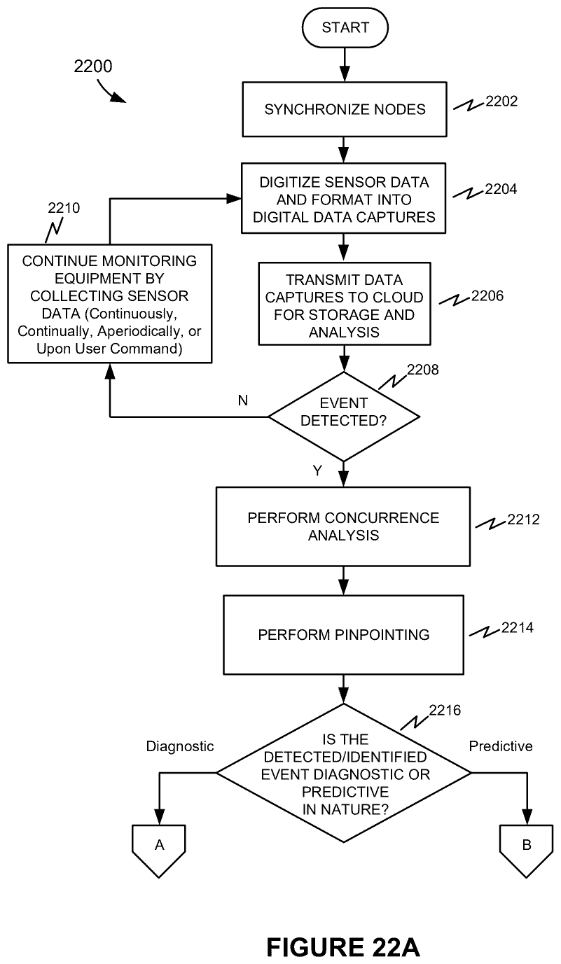

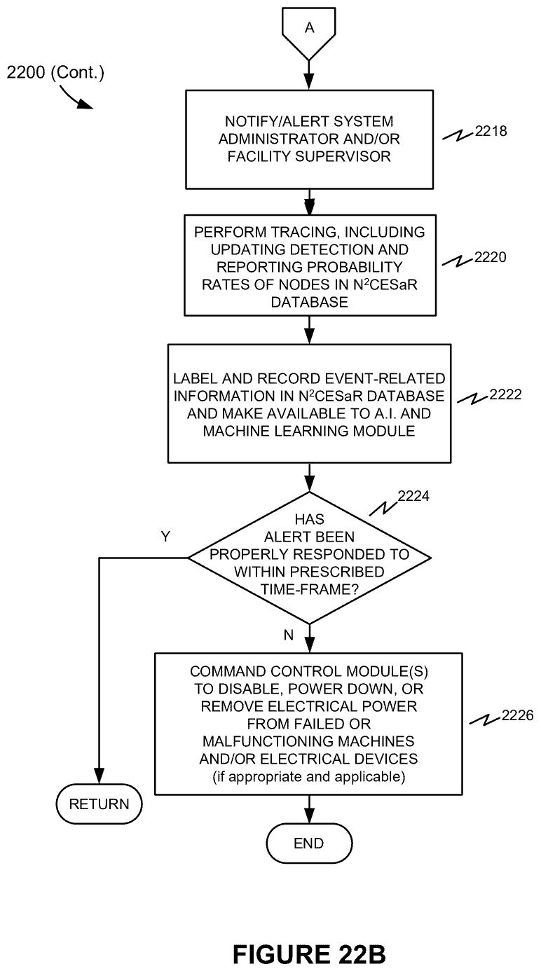

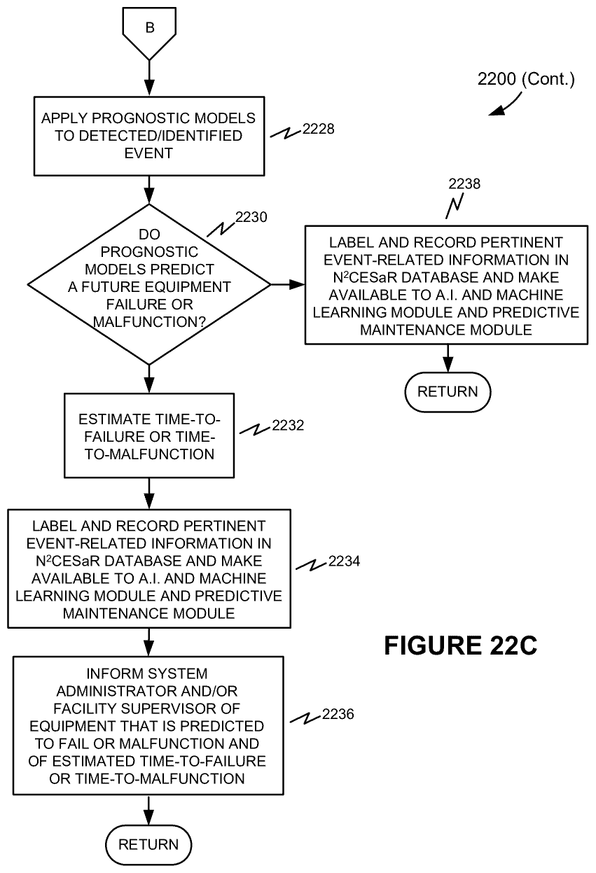

The various processes that are performed by the cloud-based computing platform 102 and the IoT-enabled industrial facility 104, and which have been described in detail above, are summarized in the flowchart presented in FIGS. 22A-22C. As with the other flowcharts presented in this disclosure, the steps and decisions in the flowchart in FIGS. 22A-22C are not necessarily performed in the order shown and should not necessarily be viewed as being a timed sequence of events. For example, decision 2208, which queries whether an event has been detected is performed continuously, independent of all other the other steps and decisions in the flowchart. The uploading of data captures from the IoT nodes 110 to the cloud-based computing platform 102 (step 2206 in FIG. 22A) is also performed independent of most other steps and decisions in the flowchart. That being said, there is one step in particular that is preferably performed before all others, and that is first step 2202 in the flowchart. At this first step 2202 the IoT nodes 110 are synchronized, first to around 1 ms precision, as described above in reference to FIG. 11, and then to sub-millisecond precision, as was described in in detail in reference to FIG. 12. The synchronization step 2202 is performed first since most all other processes and capabilities of the IIoT system 100, including the concurrence analysis described in reference to FIGS. 14-16, the pinpointing process depicted in FIGS. 18 and 19, and the tracing and event-statistics updating processes described in reference to FIGS. 20 and 21 depend on, or can only be properly performed if, the IoT nodes 110 are first synchronized. The cloud-based multi-point virtual oscilloscope capability of the IIoT system 100, including the ability to produce multi-node, time-synchronized graphs and displays of concurring events, like that in FIG. 13, would also not be possible without the IoT nodes 110 first being synchronized.

Once the IoT nodes 110 have been synchronized in step 2202, the IoT nodes can then properly time stamp their respective data captures and upload them to the cloud-based computing platform 102, as indicated by steps 2204 and 2206 in FIG. 22A. To limit the cloud data storage needed to store the often-voluminous amounts of data uploaded by the IoT nodes 110, steps 2204 and 2206 may also include configuring those IoT nodes 110 that have machines and electrical devices that operate according to detectable work cycles to upload their data captures only for times during which their respective machines and electrical devices are actually working, as was discussed in detail above in reference to FIGS. 6A and 6B.

At decision 2208, one or more cloud computers in the cloud-based computing platform 102 query as to whether an event has been detected by one or more IoT nodes 110. This decision entails identifying events by the event identifier algorithm 1000 discussed in detail above in reference to FIGS. 9 and 10. So long as no event is detected (a “no” at decision 2208), the IoT nodes 110 continue monitoring their associated machines and electrical equipment, as indicated by step 2210 in FIG. 22A, and continue collecting and uploading their data captures to the cloud-based computing platform 102, as indicated by steps 2204 and 2206, until an event is in fact detected. (Note: Like steps 2204 and 2206, step 2210 also preferably proceeds unabated (i.e., without interruption), in other words, not just following a “no” decision at decision 2208.) Once an event is detected by one or more IoT nodes 110 and the type of event is identified by the event identifier 134, at step 2212 a concurrence analysis is performed by one or more cloud computers (as discussed in detail above in reference to FIGS. 14-16), and then at step 2214 the pinpointing process described in detail above in reference to FIGS. 17-19 is performed by one or more cloud computers, in order to pinpoint the physical origin and root cause of the event.

Next, at decision 2216, a determination is made, depending on the type of event under investigation and, possibly, also its classification (as determined by the event identifier 134 and information obtained from the event library 136), whether the detected and identified event is diagnostic or predictive in nature.

If it is determined at decision 2216 that the detected/identified event is diagnostic in nature, the method 2200 continues as shown in FIG. 22B; otherwise, the event is deemed to be predictive in nature and the method 2200 continues as shown in FIG. 22C. Assuming that the detected/identified event is determined to be diagnostic in nature, at step 2218 (see FIG. 22B) the cloud-based computing platform 102 informs the system administrator and/or the facility supervisor of the location in the IoT-enabled industrial facility 104 where the event originated and, if applicable and/or appropriate, also alerts the system administrator and/or facility supervisor of any equipment-related failure or malfunction identified by or associated with the detected/identified event.

Next, at step 2220, event tracing is performed by one or more cloud computers, including updating the detection and reporting probability rates of each IoT node 110 involved in the event in the N²CESaR database 138, as discussed in detail above in reference to FIGS. 17, 20 and 21.

At step 2222, one or more cloud computers label pertinent information relating to the detected/identified event, stores it in the N²CESaR database 138, and makes it available to the A.I. and machine learning module 144.

If an alert was generated at step 2218, a determination is made by one or more cloud computers at decision 2224 as to whether the alert was properly responded to (by the system administrator or the facility supervisor) within some prescribed time frame. If the alert was properly responded to (or there was no urgent need to generate an alert at step 2218), the method 2200 returns to step 2204 (see FIG. 22A) and the method resumes there. However, if the alert was not properly addressed within the predetermined time frame (“no” at decision 2224), at step 2226 the cloud-based computing platform 102 transmits a command or commands to one or more control modules (labeled with a “C” in FIG. 1) in the IoT-enabled industrial facility 104, via the control agent 126 or web server 132 and the private and secure link 106, for example, to disable, power down, or remove electrical power from any affected equipment, for example, in the case of a broken or malfunctioning motor, to an actuator that causes, electrical power to be removed from the broken or malfunctioning motor.

In the description above, it was assumed that at decision 2216 (see FIG. 22A) a determination was made by one or more cloud computers that the detected/identified event was diagnostic in nature and the method 2200 continued in FIG. 22B. If, on the other hand, at decision 2216 one or more cloud computers determine that the detected/identified event is predictive in nature, the method 2200 continues in FIG. 22C, instead. There, beginning at step 2228, one or more cloud computers in the cloud-based computing platform 102 applies prognostic models to the detected/identified event, and if the applied prognostic models predict that equipment associated with the detected/identified event will fail or malfunction sometime in the future (a “yes” at decision 2230), then, based on information and data produced from application of the prognostic models, the one or more cloud computers compute an estimated time-to-failure or time-to-malfunction, and pertinent information relating to the detected/identified event is labeled and stored in the N²CESaR database 138 and also made available to both the A.I. and machine learning module 144 and the predictive maintenance module 142. (Note: This same (or similar) information is labeled and stored in the N²CESaR database 138, and made available to both the A.I. and machine learning module 144, regardless of whether the one or more cloud computers and prognostic models in step 2228 predict any future equipment failure or malfunction, in other words, regardless of whether a “yes” or “no” determination is made at decision 2230 (as indicated by both steps 2234 and 2238 in FIG. 22C). Assuming that the prognostic models applied to the detected/identified event do, however, predict a future failure or malfunction of equipment within the facility 104 (“yes” at decision 2230), after the one or more cloud computers computes an estimated time-to-failure or time-to-malfunction at step 2232, the one or more cloud computers inform the system administrator and/or facility supervisor at step 2236 of the equipment that is predicted to fail or malfunction and of the equipment's estimated time-to-failure or time-to-malfunction. The time-to-failure or time-to-malfunction notification may be generated by the report generator 130, for example, and emailed to the system administrator and/or facility supervisor in an email by an email server in the cloud-based computing platform 102, or may be made available on one or more web pages on a web server (as indicated by the email and web server block 132 in FIG. 1) that can be accessed via the local and remote admin portals 116 and 122 and/or the general purpose U.I. 118 within the IoT-enabled industrial facility 104. Finally, once the system administrator and/or facility supervisor have been notified, the method 2200 returns to step 2204 in FIG. 22A.

While various embodiments of the present invention have been described, they have been presented by way of example and not limitation. It will be apparent to persons skilled in the relevant art that various changes in form and detail may be made to the exemplary embodiments without departing from the true spirit and scope of the invention. Accordingly, the scope of the invention should not be limited by the specifics of the exemplary embodiments but, instead, should be determined by the appended claims, including the full scope of equivalents to which such claims are entitled.

1. A method of determining the origin of an event in an electrical distribution network of an internet of things (IoT)-enabled industrial facility, comprising:
synchronizing a plurality of IoT nodes coupled to a plurality of electrical machines and electrical devices within the electrical distribution network;
temporally correlating an event captured by two or more IoT nodes of the plurality of IoT nodes, the event comprising a voltage or current transient or waveform or other voltage and/or current-related characteristic having a unique electrical signature; and
using a single-line drawing (SLD) of the electrical distribution network and localization information gained from temporally correlating the event, pinpointing an origin of the event within the electrical distribution network.

2. The method of claim 1, wherein pinpointing the origin of the event comprises determining a root cause of the event, including identifying any machines and/or electrical equipment within the IoT-enabled industrial facility that caused the event or that is/are associated with the event.

3. The method of claim 1, wherein temporally correlating the event and pinpointing the origin of the event are performed by one or more cloud computers using data captures received from the plurality of IoT nodes, and synchronizing the plurality of IoT nodes is performed by a computer located within the IoT-enabled industrial facility.

4. The method of claim 1, wherein synchronizing the plurality of IoT nodes, temporally correlating the event, and pinpointing the origin of the event are performed by one or more cloud computers using data captures received from the plurality of IoT nodes.

5. The method of claim 1, wherein synchronizing the plurality of IoT nodes comprises synchronizing the plurality of IoT nodes to sub-millisecond precision.

6. The method claim 1, wherein temporally correlating the event comprises:
identifying sets of IoT nodes from among the plurality of IoT nodes that are coincident; and
for each identified set of coincident IoT nodes, resolving conflicts among said each identified set of coincident IoT nodes concerning whether the event did or did not occur.

7. The method of claim 6, wherein resolving conflicts among said each identified set of coincident IoT nodes comprises:
computing a weighted sum depending on probability detection rates associated with all IoT nodes that are members of said each identified set of coincident IoT nodes; and
based on the weighted sum, establishing consensus among said each identified set of coincident IoT nodes as to whether the event did or did not occur.

8. The method of claim 7, wherein the probability detection rates of each IoT node are non-static and vary depending on the type of the event.

9. The method of claim 1, wherein temporally correlating the event comprises resolving conflicts among IoT nodes of the plurality of IoT nodes as to whether the event occurred or did not occur.

10. The method of claim 9, further comprising storing and updating over time probability detection rates of IoT nodes from the plurality of IoT nodes that properly detected the event and probability detection rates of other IoT nodes from the plurality of IoT nodes that should have detected the event but did not.

11. The method of claim 10, wherein storing and updating over time the probability detection rates further comprises storing and updating over time probability detection rates for other events of other types different from said event.

12. The method of claim 9, further comprising storing and updating over time probability reporting rates of IoT nodes from the plurality of IoT nodes that properly reported the event and probability reporting rates of other IoT nodes from the plurality of IoT nodes that should have reported the event but did not.

13. The method of claim 6, wherein pinpointing the origin of the event within the electrical distribution network comprises:
constructing an N-ary tree data structure having a one-to-one correspondence with the SLD, with each level in the N-ary tree data structure including one or more supernodes, each supernode comprising either an identified set of coincident IoT nodes having a consensus that the event occurred or an identified set of coincident IoT nodes having a consensus that the event did not occur;
forming links between those supernodes in the various levels of the N-ary tree data structure that comprise sets of coincident IoT nodes having a consensus that the event occurred; and
starting at a lowest level of the N-ary tree data structure, tracing a path among the links to a level in the N-ary tree data structure that localizes the event and corresponds to the physical location within the IoT-enabled industrial facility where the event originated, as represented in the SLD.

14. The method of claim 13, further comprising increasing or decreasing a true positive detection rate of each IoT node in each supernode depending on whether said each IoT node is a member of an identified set of coincident IoT nodes having a consensus that the event occurred or is a member of an identified set of coincident IoT nodes having a consensus that the event did not occur.

15. An industrial internet of things (IIoT) system, comprising:
an IoT-enabled industrial facility including an electrical distribution network having a plurality of electrical machines and other electrical devices and a plurality of IoT nodes coupled to the plurality of electrical machines and other electrical devices; and
a cloud-based computing platform, communicatively coupled to the IoT-enabled industrial facility, including one or more cloud computers configured to temporally correlate events contained in data captures captured by IoT nodes of the plurality of IoT nodes and, based on localization information produced from the temporal correlation of a given event, pinpoint a location within the IoT-enabled industrial facility that the given event originated.

16. The IIoT system of claim 15, wherein the one or more cloud computers are configured to synchronize the plurality of IoT nodes to a common time reference, prior to temporally correlating the given event.

17. The IIOT system of claim 15, wherein the one or more cloud computers is/are further configured to resolve conflicts among coincident IoT nodes concerning whether the given event occurred or did not occur.

18. The IIOT system of claim 17, further comprising an event statistics database configured to catalog probability detection rates of each IoT node of the plurality of IoT nodes.

19. The IIoT system of claim 18, wherein the probability detection rates are event-type dependent and the one or more cloud computers is/are configured to record and update probability detection rates for multiple event types in the event statistics database for each IoT node.

20. The IloT system of claim 19, wherein the probability detection rates include event-type-dependent true positive and false negative detection rates for each IoT node, and the one or more cloud computers is/are configured to increase the event-type-dependent true positive detection rates in the event statistics database for all coincident IoT nodes that should have and did detect the given event and increase the event-type-dependent false negative detection rates in the event statistics database for all coincident IoT nodes that should have but did not detect the given event.

21. The IloT system of claim 18, wherein the event statistics database is stored on one or more cloud-based storage devices within the cloud-based computing platform.

22. The IloT system of claim 18, wherein the event statistics database is stored locally on a storage device within the IoT-enabled industrial facility.

23. The IIoT system of claim 18, wherein the event statistics database is stored and updated distributively in a blockchain.
